(19) United States
(12) Patent Application Publication
(10) Pub. No.: US 2002/0046286 A1
(43) Pub. Date: Apr. 18, 2002

(54) Attribute and application synchronization in distributed network environment

(76) Inventors: R. Russell Caldwell, Atlanta, GA (US); Michael C. Merrill, Marietta, GA (US); Michael L. Greene, Atlanta, GA (US); Roy G. Wells, Atlanta, GA (US); Arnshea Clayton, Atlanta, GA (US)

Correspondence Address: Jon M. Jurgovan, Esq., Morris, Manning & Martin, LLP, 1600 Atlanta Financial Center, 3343 Peachtree Road, NE, Atlanta, GA, 30326-1044, US

(21) Appl. No.: 09/738,916

(22) Filed: Dec. 13, 2000

Related U.S. Application Data
(63) Continuation-in-part of application No. 09/459,734, filed on Dec. 13, 1999.
(60) Provisional application No. 60/170,460, filed on Dec. 13, 1999.

(51) Int. Cl. G06F 15/16

(52) U.S. Cl. 709/229

(57) ABSTRACT

A disclosed method includes mapping data identifying at least one first application module to respective message type data, and storing the message type data in association with the data identifying the first application module in a first database accessible to a first server. The method includes mapping universal resource locator for internetwork access to at least one second server, to respective message type data. The first method further includes storing the message type data in association with a respective universal resource locator in the first database, mapping second attribute data to first attribute data, and storing the second attribute data in association with the first attribute data in the first database. Similar steps can be used to prepare the second server and database for operation. Using the first client device a user can generate message type data transmitted from the first client device to the first server that determines whether the received message type data is associated with a first application module. If so, the first server runs the first application module using optional attribute data. The first server also determines whether the received message type data is associated with universal resource locator. If so, the universal resource locator is used to transmit the message type data from the first server over the internetwork to the second server. The second server determines whether the message type data is mapped to a second application module in the second database. If so, the second server runs a second application module corresponding to the message type data.

### CROSS-REFERENCE TO RELATED APPLICATIONS

This document is a continuation-in-part under Title 35, United States Code §120 of nonprovisional application 09/459,734 filed Dec. 13, 1999 naming R. Russell Caldwell, Michael C. Merrill, Michael L. Greene, and Roy G. Wells as inventors.

This document also claims earlier filing under Title 35, United States Code §119(e) of provisional application 60/170,460 filed Dec. 13, 1999 naming R. Russell Caldwell, Michael C. Merrill, Michael L. Greene, and Roy G. Wells as inventors.

The above-identified applications are assigned to the same entity, Novient, Inc., a Georgia corporation.

### COPYRIGHT AUTHORIZATION

A portion of the disclosure of this document contains material that is subject to copyright protection. Permission is hereby given by the owner, Novient, Inc., Atlanta, Ga., binding upon its successors and assigns, to reproduce, distribute, or publicly display this document to the extent required by the Patent Laws embodied in Title 35, United States Code. However, Novient, Inc. reserves all other rights whatsoever in the copyright material herein disclosed.

### BACKGROUND OF THE INVENTION

1. Field of the Invention

The invention is related to data access and management, or “data syncing”, between servers via internetwork such as the “Internet”. Data remains in the databases of the servers unless access thereto is required by another server. The servers can access each other's data without the need to receive all of the data from the other server. The data in the system is thus distributed over the servers rather than “pushing” the data around the servers so that all servers have the same data, or providing a central server the stores all data for all servers.

2. Description of the Related Art

Many techniques for permitting data intercommunication between servers and their databases via an internetwork are known. One is the “push” technique that transmits data updates generated at any server to all other servers via the internetwork so that the servers have the same data in their databases. This technique involves pushing massive amounts of data around the internetwork. The amount of data exposed if a breach in security occurs is relatively large. In addition, the amount of time required to move such large amounts of data between servers via the internetwork absorbs considerable time and processing capability of the servers. It would be desirable to provide a method that permits data to reside at the servers where it is generated and used, and yet to provide second access to the data to a privileged degree.

Another technique known as the “hub” technique that stores all data for all servers at one site accessed via the internetwork. However, this technique also suffers from certain disadvantages. For example, in the event of data loss at this site, no servers will be have the data for recovery thereof. In addition, the amount of processing capability required at the hub site will be relatively large, and the site equipment therefore relatively expensive. It would therefore be desirable to provide a method that allows the data to reside at the servers where such data is generated and managed, yet be accessible to other servers via the internet in a secure fashion.

Another problem related to the invention is that the data at one site may not exactly match that at another site. For example, if one wishes to find data pertaining to “newspaper advertisers” in the culture of the first site, and the culture of the second site has no data for “newspaper advertisers” but has data for “printed media advertisers”, the user at the first site can request such data at the second site if privileged at the second site to do so. It would be desirable to provide a method that can be used to associate first and second data to permit enhanced accessibility of data between the sites.

### SUMMARY OF THE INVENTION

The disclosed system, methods, media, and signals have as their objects to overcome the above-stated problems with previous techniques, and do in fact overcome such problems and attain significant advantages over the prior art.

A first method of the invention can comprise mapping data identifying at least one first application module to respective message type data, and storing the message type data in association with data identifying the first application module in a first database accessible to a first server. The method can comprise mapping URL data for access to at least one second server, to respective message type data. The second database can be accessible to at least one second server. The method can further comprise storing the message type data in association with respective URL data in the first database. The method can comprise mapping second attribute data to first attribute data, and storing the second attribute data in association with the first attribute data in the first database so as to be accessible to the first server. The first method can further comprise mapping at least one second application module to respective message type data, and storing the message type data in association with the second application module in the second database. The method can also comprise mapping URL data for internetwork access to the first database, to respective message type data, and storing the message type data in association with respective URL data in the second database. The method can further comprise mapping first attribute data to second attribute data, and storing the first attribute data in association with the second attribute data in the second database. The first and second servers can thus be prepared to trigger first and/or second application modules. A client device can be operated by a user to generate a signal with message type data. Depending upon the nature of the message type data, the first server can retrieve and execute a first application module mapped to the message type data. Optionally, the user can operate the client device to transmit first attribute(s) to the first server for use in executing the first application module. Execution of the first application module designated by the message type data can result in the first server generating and transmitting message type data from the first server to the second server using the URL for the second server. In response to receiving message type data from the first server, the second server can retrieve and execute a second application corresponding to such message type data. The first server can transmit first attribute(s) to the second server for its use in executing the second application(s). The second server can retrieve second attribute(s) corresponding to the first attribute(s) for use in its execution of the second application module(s). If execution of the first and/or second application(s) produces result data, such result data can be returned by the first and/or second servers to the client device for display.

The first method can further comprise mapping data identifying at least one second application module to respective message type data, and storing the message type data in association with the data identifying the second application module in the second database. The method can also comprise mapping URL data for internetwork access to the first database, to respective message type data, and storing the message type data in association with respective URL data in the second database. The method can further comprise mapping first attribute data to second attribute data, and storing the first attribute data in association with the second attribute data in the second database.

The mappings of the first and second application modules to the same message type data and the mappings of the first attribute data to the second attribute data, permit meaningful interaction between first and second servers even though they may be operating in very different parts of the world. For example, if the message type data generated at a first client device designates first and/or second application modules used to execute a search request, and if the attribute data generated at the first client device that is associated with message type data identifies a particular worker data, say, “C++ programmer”, the mapped associations of the first and second application modules and the first and second attribute data can permit searches to be conducted to find workers with the same or similar skills. In addition, there need be no exact match between the first worker data definition defined by the first attribute data and the second worker data definition, so that workers with skills close to that specified by the first attribute data can be found at the second location to staff a particular work project, for example. This is but one example of how the invention can be used to increase the capability of first and second servers to interact, and those of ordinary skill will understand that there are numerous other useful applications of the invention. The mapping of the second attribute data and first attribute data can be performed with a predetermined function. For example, the second attribute data and the first attribute data can be assigned numeric values as to relative similarity based on a execution of an appropriate search engine, and comparison of such values can be used to determine whether first attribute data is within a predetermined value from the second attribute data, and thus matches the second attribute. The message type data can be transmitted between the first and second servers in an extensible Markup Language (XML) document embedded in a hypertext transfer protocol (HTTP) message. The method can also include logging the message received at the second server with time stamp data, receiving the result data transmitted from the second server at the first server, logging the result data received with return time data, comparing the time stamp data with the return time data, and determining at the first server whether the result data is valid, based on the comparison. The use of time stamp data and return time data can be used to eliminate result data that is too aged to be of interest to a user. To ensure security of the data transmitted between the first and second servers, the method can include encrypting messages containing message type data, attribute data, and/or result data transmitted between the first and second servers, and decrypting received messages at the receiving server. Such encryption/decryption can be performed using public and private key data prestored in association with respective network addresses (e.g., universal resource locators (URLs)) on the network.

Another method of the invention can be used to produce a table mapping first and second attributes. The method can comprise indexing a fromlist and tolist of attribute(s). Indexing can involve replacing capital letter(s) with lower case letter(s), and eliminating any commas, hyphens, periods, colons, semi-colons, or other non- distinguishing data from the character string of the attribute(s), for example. The method can comprise selecting an attribute(s) from the tolist, searching the fromlist of attribute(s) with the selected attribute from the tolist, and determining whether an exact match of the selected attribute from the tolist is present in the fromlist of attributes. If this determination establishes that the selected attribute from the tolist is present in the fromlist of attributes, the method can comprise storing the attribute from the tolist in association with the attribute from the fromlist. If the determination establishes that the selected attribute from the tolist is not present in the fromlist, the method can comprise truncating the character string of the attribute from the tolist, optionally by word boundaries. The method can comprise searching the fromlist of attributes with the truncated tolist attribute string, and determining whether a partial match of the selected attribute from the tolist matches an attribute from the fromlist. If this determination establishes a partial match of the selected attribute from the tolist partially matches an attribute from the fromlist, the method can comprise storing the attribute from the tolist in association with the attribute from the fromlist. On the other hand, if this determination establishes that the selected attribute from the tolist does not partially match an attribute from the fromlist, the method can comprise determining whether greater than a predetermined number of character words remain in the string of the attribute from the tolist. If this determination establishes that greater than the predetermined number of character words remain in the string of the attribute from the fromlist, the truncating of the character string and subsequent steps can be repeated. If the determination establishes that greater than the predetermined number of character words do not remain in the string of the attribute from the fromlist, the method can comprise searching the fromlist of attribute(s) with the selected attribute from the to list for common character words, and determining whether a minimum number of words of an attribute from the fromlist match the attribute from the tolist. If the determining establishes that the minimum number of words of the attribute from the from list match the attribute form the tolist, the method can comprise storing the attribute form the tolist in association with the attribute from the fromlist. If this determination establishes that greater than the predetermined number of character words do not remain in the string of the attribute from the fromlist, the method can comprise searching the fromlist of attribute(s) with the selected attribute from the to list for common character words, and determining whether a minimum proportion of words of an attribute from the fromlist match the attribute from the tolist. If this determination establishes that the minimum proportion of words of the attribute from the from list match the attribute from the tolist, the method can comprise storing the attribute form the tolist in association with the attribute from the fromlist. The method can further comprise reviewing matches of attributes from the fromlist and tolist by an expert or experienced person, and determining whether the attributes form the fromlist and tolist match. If the determining step establishes that the attributes from the fromlist and tolist do not match, the method can comprise determining whether the fromlist has any attribute(s) corresponding to the attribute from the tolist. If this determination establishes that an attribute(s) in the fromlist matches the attribute from the tolist, the method can comprise storing the attribute from the tolist in association with the attribute(s) from the fromlist.

Another method of the invention comprises receiving a first attribute, storing the first attribute, indexing the first attribute and a second attribute(s), finding match(es) if any between the first and second attributes, and storing match(es) between the first and second attributes. These steps can be performed at a first site, and the method can further comprise transmitting the first attribute from the first site to a second site. At the second site, the method can further comprise storing the first attribute, indexing the first attribute and a second attribute(s), finding match(es) if any between the first and second attribute(s), and storing the second attribute(s) in correspondence with the first attribute.

Another method of the invention comprises receiving a first attribute, checking a first database for the first attribute, and determining whether the first attribute is present in the first database. If the first attribute is not present in the first database, the method can comprise storing the first attribute, indexing the first attribute and second attribute(s) stored in the first database, finding match(es) if any between the first and second attributes, and storing any match(es) of the first and second attributes if found. If the first attribute is present in the first database, the method can comprise determining whether the first attribute or attribute group has changed. If the determination indicates that the first attribute or attribute group has changed, the method can comprise deleting the previous first attribute and all dependent match(es) with the second attribute(s) from the first database. The foregoing steps can be performed at a first site, and that method can further comprise transmitting the first attribute to a second site. At the second site, the method can comprise receiving the first attribute, checking a second database for the first attribute, and determining whether the first attribute is present in the second database. If the first attribute is not present in the second database, the method can comprise storing the first attribute, indexing the first attribute and second attribute(s) stored in the second database, finding match(es) if any between the first and second attributes, and storing any match(es) of the first and second attributes, if found, in the second database.

If the first attribute is present in the second database, the method can further comprise determining whether the first attribute or attribute group has changed. If this determination indicates that the first attribute or attribute group has changed, the method can comprise deleting the previous first attribute and all dependent match(es) with the second attribute(s) from the second database. The method can comprise determining whether the attribute description has changed. If the determination indicates that the attribute description has changed, the method can comprise updating the description of the first attribute in the second database. The first and second attribute(s) can be members of an attribute group, or can be associated with an account.

A method can comprise, at a first site, deleting an attribute record from a first database, deleting associated attribute match(es) from the first database, generating a request to delete the attribute record, and transmitting the request to delete the attribute record from the first site to a second site. The method can further comprise, at the second site, receiving the request to delete the attribute record, deleting the attribute record from a second database, and deleting associated match(es) with the attribute record from the second database. The attribute record can pertain to an attribute group or an account.

A method can comprise synchronizing first and second attributes at a first site, transmitting a request to synchronize attributes from the first site to a second site, and synchronizing first and second attributes at a second site. The method can further comprise receiving first attribute(s), deleting previous first attribute(s), deleting all match(es) of second attributes from the first attribute(s), indexing the received first attribute(s) and second attribute(s) stored in a first database, finding match(es) of the first attribute(s) to the second attribute(s), and storing the match(es) of the first and second attribute(s) in the first database. The first attribute(s) can be transmitted from the first site to a second site. The method can comprise receiving first attribute(s), deleting previous first attribute(s) from a second database, deleting dependent match(es) of the first and second attribute(s) from a second database, indexing the received first attribute(s) and second attribute(s) stored in the second database, finding match(es) of the first attribute(s) to the second attribute(s), and storing the match(es) of the first and second attribute(s) in the second database. The foregoing steps can be performed for an attribute group or account.

A machine-readable medium that stores a program is also disclosed herein. The machine-readable medium includes a machine-executable program for mapping data identifying at least one first application module to respective message type data, storing the message type data in association with the data identifying the first application module in a first database accessible to a first server, mapping a universal resource locator (URL) of a second server to respective message type data, storing the message type data in association with respective universal resource locator in the first database, mapping second attribute data to first attribute data, and storing the second attribute data in association with the first attribute data in the first database, the first database accessible to the first server.

A signal disclosed in this document comprises first tags indicating a message type, and second tags within the first tags indicating attribute(s). The first tags can be <AttributeElement> and </AttributeElement> tags to delineate the attribute(s). The signal can comprise third tags within the second tags indicating the name of the attribute, and fourth tags indicating the description of the attribute(s). The third tags can be <name> and </name> tags that delineate the name of the attribute(s). The fourth tags can be <description> and </description> tags. The first tags can indicate various message types. For example, the first tags can be <AttributeSyncInsert> and </AttributeSyncInsert> tags can indicate an attribute-insert application to be executed by a server receiving the signal. The first tags can be <AttributeSyncDelete> and </AttributeSyncDelete> tags indicating an attribute-delete application to be executed by a server receiving the signal. The first tags can be <AttributeSyncUpdate> and </AttributeSyncUpdate> tags indicating an attribute update application to be executed by a server receiving the signal. The first tags can be <AttributeSyncAll> and </AttributeSyncAll> tags indicating a synchronize-all-attributes application to be executed by a server receiving the signal.

A system disclosed herein is coupled via a network and operable by a first user. The system comprises a first site and second site coupled via the network. The first site has at least one first client device, a first server, and a first database storage unit. The first client device is operable by a first user to input a message type and first attribute(s). The first server is coupled to receive the message type and first attribute(s) from the first client device, and can execute a first application using the first attribute(s) based on the message type. The first server determines whether a request to execute a second application is to be generated based on the message type. The first server transmits the message type and first attribute(s) to the second server via the network if the first server's execution of its application module indicates it should do so. determines that the message type indicates the second application should be executed. The second site has a second server and a second database storage unit. The second server is coupled to receive the message type from the first server. The second server determines second attribute(s) corresponding to the first attribute(s). The second server can execute a second application based on the message type and second attributes. The second site can comprise a second client device operable by a second user. A second user can input a message type and second attribute(s) with the second client device. The second client device can transmit the message type and second attribute(s) to the second server. The second server can execute the second application based on the message type using the second attribute(s). The second server can determine whether the first application should be executed based on the message type. The second server transmits the message type and second attribute(s) to the first server if the second server's execution of the second application module so dictates. The first server can receive the message type and second attribute(s) if transmitted by the second server. The first server can determine first attribute(s) corresponding to the second attribute(s). The first server can execute the first application based on the determined first attribute(s).

These together with other objects and advantages, which will become subsequently apparent, reside in the details of construction and operation as more fully described hereinafter, reference being made to the accompanying drawings, forming a part hereof, wherein like numerals refer to like parts throughout the several views.

### BRIEF DESCRIPTION OF THE DRAWINGS

FIG. 1 is a view of a system to which the disclosed methods can be applied;

FIG. 2 is a block diagram of a local server;

FIG. 3 is a block diagram of a first client device;

FIG. 4 is a block diagram of a database storage unit;

FIGS. 5A and 5B are flowcharts of processing performed by a server(s) to map application(s) and attribute(s) in the disclosed method(s);

FIGS. 6A and 6B are flowcharts of processing performed in operation of the disclosed system and methods;

FIG. 7 is a flowchart of processing a program executed by a server to retrieve an application;

FIG. 8 is a flowchart of processing executed by a server to retrieve the universal resources locator (URL) of another server;

FIG. 9 is a flowchart of a processing performed by a server(s) to retrieve second attribute(s) using first attribute(s);

FIG. 10 is a flowchart of processing executed by a server to execute an application under request from another server;

FIG. 11 is a flowchart of processing executed by a server to retrieve first attribute(s) using second attribute(s) of another server;

FIGS. 12A and 12B are flowcharts of processing performed to determine matches between first and second attributes;

FIG. 13 is a flowchart of a method performed by an expert to verify machine-generated match(es) of attribute(s);

FIGS. 14A-14C are flowcharts of a method for inserting an attribute into a database;

FIG. 14D is a flowchart of a method for deleting an attribute;

FIGS. 14E-14F are flowcharts of a method for synchronizing attribute(s);

FIG. 14G is a flowchart of a method for synchronizing attribute(s) in response to request from another server of the system;

FIGS. 16A and 16B are views of a message structure of an xml document for transmitting message type(s) and attribute(s) between server(s);

FIGS. 17A-17E are views of message structures for attribute(s) and message type(s);

FIGS. 18A -18B are relatively detailed views of the disclosed system;

FIGS. 19 are relatively detailed flowcharts of processing that can be performed by server(s) of the system in the performance of the disclosed methods; and

FIG. 20 is a view of a machine-readable medium.

### DESCRIPTION OF THE PREFERRED EMBODIMENTS

1. Definitions

“And/or” means either or both.

“Communication interface unit” can include a modulator/demodulator (“modem”), a waveguide, optical or wireless transceiver, Ethernet® card, or other device that permits a server or device to access a network.

“Coupled” refers to joining a client device(s), server(s), or database storage unit(s) so as to permit signals to propagate therebetween. Such signals can be in electronic form and transmitted between coupled elements by a conductive line such as a wire or cable or other waveguide, or via wireless transmission of signals through air or other media, for example. Alternatively, such signals can be in optical form and transmitted via optical fiber or other waveguide, or by transmission of signals through air, space or other media, for example.

“Database storage unit” refers to a memory storage with random-access memory, hard-disk drive, tape or other storage medium type for the storage of data. The data storage unit can be controlled with commercially-available software packages such as SQL Server 7.0 from Microsoft Corporation, Redmond, Wash., or Oracle 7.0 from Oracle® Corporation, Redwood City, Calif. The web server can communicate with the data storage unit through an application program interface (API) such as Java DataBase Connectivity (JDBC) or Open DataBase Connectivity (ODBC).

“Display unit” can be a flat-panel liquid crystal display (LCD) or a cathode ray tube (CRT), for example.

“Document”, “web page” or “web page document” refers to a document in hypertext mark-up language (HTML), extensible mark-up language (XML), or other language that includes a machine-readable code that can be used to generate a display with a web browser.

“File” refers to a set or collection of data.

“Graphical user interface” or “GUI” refers to the display and input unit of a client device that a user operates to interact with the client device.

“Index” refers to the process of organizing character strings in a manner that facilitates rapid searching and retrieval. This process can include eliminating features of character strings that do not distinguish the nature of the attribute. Such features can include any periods, commas, slashes, hyphens, colons, semicolons, exclamation points, capitalization, etc.

“Input device” refers to a keyboard, mouse, wand or any other device that can be operated by a user to input commands or data into a client device.

“Log in” and “log out” refer to beginning and ending steps of a session of interaction between a client device and a server. Generally, “log in” entails entering user name and password at a client device and submitting these to a server. The server and/or database storage unit can be used to store user data associated with the user name and password.

“Memory” or “Processor-readable memory” includes a random-access memory (RAM), read-only memory (ROM), programmable read-only memory (PROM), electrically-erasable read-only memory (EEPROM), compact disc (CD), digital versatile disc (DVD), a magnetic storage medium such as a floppy disk or cassette, hard disk drive, and/or other storage device. Such memory can have a byte storage capacity from one Megabyte to several Gigabytes or more, for example.

“Network” can be first area network (LAN), wide area network (WAN), metropolitan area network (MAN), “the Internet” or “world wide web”, a virtual private network (VPN) or other network, for example. The “network” establishes communication between applications running on client device and server(s). Such communication can be in accordance with the ISO/OSI model, for example.

“Operator” refers to a programmer or systems administrator of either the resource provider subsystem or the resource distribution subsystem.

“Operating system” is a computer program that enables a processor within a web server or client device to communicate with other elements of such systems. Such operating systems can include Microsoft® Windows 2000™, Windows NT™, Windows 95™, Windows 98™, or disc-operating system (DOS), for example. Such operating systems can also include the Java-based Solaris® operating system by Sun Microsystems, the UNIX® operating system, LINUX® operating system, and others.

“Processor” can be a microprocessor such as a Pentium® series microprocessor commercially-available from Intel® Corporation, an Athlon® series microprocessor from Advanced Micro Devices, Inc., a microcontroller, programmable logic array (PLA), field programmable gate array (FPGA), programmable logic device (PLD), programmed array logic (PAL), or other device.

“machine-readable medium” includes an electronic, magnetic, magnetoelectronic, micromechanical, or optical data storage media. The machine-readable medium can include compact-disk read-only memory (CD-ROM), digital versatile disk (DVD), magnetic media such as a floppy-disk or hard-disk, hard-disk storage units, tape or other data storage medium.

“(s)” at the end of a word means “one or more.” For example, “part(s)” means “one or more parts.”

“Synchronize” means to match application(s) and/or attribute(s).

“Transmission media” includes an optical fiber, wire, cable, or other media for transmitting data in optical or electric form. “Universal Resource Locator” or “URL” is the address of a device such as a client or server accessible via internetwork.

“User” generally means refers to a human operator of a client device.

“Client device” is a device that accesses resources of another device (e.g., server) via a network. The client device can be a personal computer, a network terminal, a personal digital assistant, or other computing or processor-based device, or a thin-client without processing capability.

“Web browser” or “browser” is an application program that has the capability to execute and display an HTML document, and that interacts with one or more servers via a network. For example, the web browser can be Internet Explorer® version 5 program available from Microsoft® Corporation, Redmond, Wash., or Communicator® version 4.5 program available from Netscape, Inc. “Web browser” also encompasses within its meaning HTML viewers such as those used for personal digital assistants (PDAs).

“Web server” or “server” generally refers to a computing device such as the Power Edge™ brand series of servers from Dell Corporation, Round Rock, Tex., that is capable of executing a Java® or other server application.

2. The General System and Methods

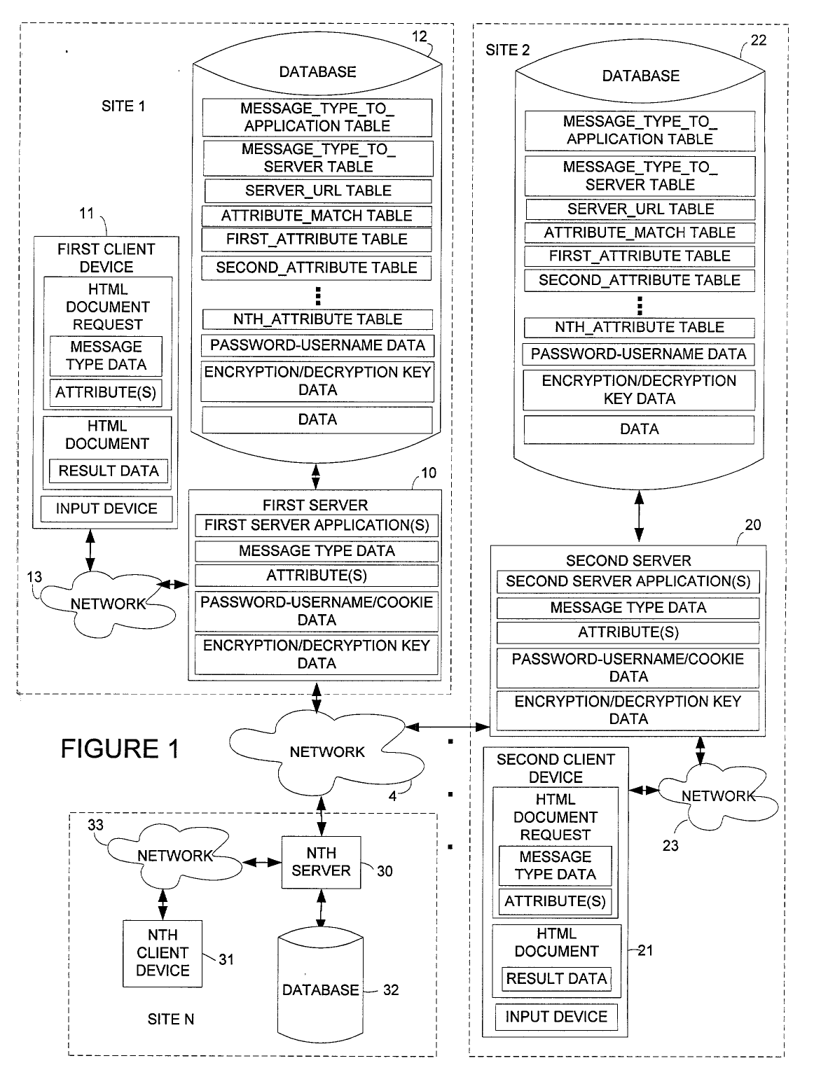

FIG. 1 shows a system to which the invented methods can be applied. As shown in FIG. 1, the system includes a first site 1, and one or more second sites (sites 2-N are indicated in FIG. 1). The sites 1-N can be intercoupled via a network 4. The sites 1, 2, . . . , N can be located at relatively great distances from one another, possibly on different continents. The server sites can be operated by one business or separate organizations. The first site 1 includes a first server 10, first client device 11, a first database storage unit 12 coupled to communicate with one another via the network 13. The second site 2 includes a second server 20, a second client device 21, a second database storage unit 22, and a network 23. The second server 20 is coupled to the client device 21 via the network 23, and is coupled to the second database storage unit 22. Other second sites can be included within the system, and second site N is illustrated as an example of such configuration. Second site N includes a second server 30, second client device 31, second database storage unit 32, and a network 33. The second server 30 is coupled to the second client device 31 via the network 33, and is coupled to the second database storage unit 32. The sites 1,2, . . . N or more specifically, the servers 10, 20, 30 can be coupled via the network 4. The network 4 can be the Internet, for example. The networks 13, 23, 33 can be LANs, MANs, WANs, or the Internet, for example.

The first server 10 is coupled to the client device 11 via the network 13. The first server 10 is also coupled to the database storage unit 12 and the network 4. The first client device 11 can be a personal computer, a personal digital assistant, or other computing device, or alternatively can be a so-called thin client with relatively little or no data processing capability. The client device 11 provides the user interface that permits a first user to view a display, listen to sounds, etc. generated by the hypertext mark-up language (HTML) or extensible mark-up language (XML) document made available to the client device by the first server 10 via the network 13. The first client device 11 and first server 10 can communicate with one another over network 13 using transfer control protocol/internet protocol (TCP/IP), for example. Security of communication between the first client device 11 and the first server 10 can be established by user name and password in a “log-in” procedure. The log-in procedure can be used to establish a session between the first client device 11 and the first server 10, and encryption and decryption keys for the session can be used by the first client device and first server to secure data transmission over network 13, as is well-known in this technology. Alternatively, security of transmissions between the first client device 11 and the first server 10 can be established through cookie data stored in the first client device 11 that the first server 10 uses to determine encryption/decryption keys for use in communication signals transmitted between the first client device 11 and the first server 10. The cookie data identifies the first client device 11 to the first server 10 upon the first client device's accessing the first server 10, as is well-known in this technology. In the exemplary embodiment of FIG. 1, the first client device 11 generates a display based on a request HTML document. The first user can input a command that is associated with an application(s) to be executed on either the first and/or second server(s) 10, 20. The first user can input the command by using an input device of the first client device 11 to generate message type data that specifies the first and/or second application(s) to be executed by an association(s) between the message type data and data identifying respective application(s) stored in the first and/or second server(s). Input of the command and/or attributes can be performed with an input device of the first client device 11. For example, the message type data can designate application module(s) such as include insert-data, update-data, remove-data, or send-all-data directed to the first and/or second site(s) for handling of data hosted by such site(s). Execution of the designated application on the first and/or second server(s) can produce result data that the server(s) can transmit to the first client device 11 as an HTML or XML document. The first client device 11 can display an HTML document for display of the result data generated by execution of the application(s) designated by the first user.

The first database storage unit 12 can store various tables used by the first server to determine and execute the application commanded by the first user with the first client device 11. More specifically, the first database stored by unit 12 can include message_type_to_application, message_type_to_server, server_URL, first_attribute, second_attribute, . . . , nth_attribute, and attribute_match tables. In addition, the first database storage unit 12 can store the first application(s). The message_type_to_application table can be used to map a message type to its respective application. In addition, the message_type_to_application table can be used by the first server 10 to determine whether the message type is such that a message should be transmitted to the second server(s) 20, 30 so as to cause a second application to be executed. The message_type_to_server table maps a message type to a URL of a second server so that the first server 10 can send transmit the message type data and attribute(s) to the second server for execution of an application designated by that message type. The attribute_match table maps first attribute(s) to second attribute(s) stored in the first_attribute and second_attribute tables in the first and second databases, respectively. The server_URL table maps the identity of a second server to a URL of that second server. The database storage unit 12 can store the first server application(s). The database storage unit 12 can store password and user name data or cookie data to verify the identity of the first client device 11 or its user before permitting access to use of an application(s). The first database storage unit 12 can store encryption/decryption data for use in encrypting data transmitted between the first server 10 and the second server(s) 20, 30. The first database storage unit 12 can also store data that can be accessed through insert-data, delete-data, update-data, or send-all data commands. Such data can also result from execution of a first application by the first server 10.

The first server 10 can receive a command message from the first client device 10. The first server 10 uses the message type data and optional attribute(s)(the attribute(s) may not be required for all message types) included within the received message to retrieve, load, and execute the first application stored in the first server's memory. In the execution of the first application, the first server 10 can use the attribute(s) received from the first client device 11. If the first server 10 generates result data in its execution of the first application, the first server 10 generates and transmits an HTML or XML document including such result data, and transmits such result data to the first client device 11. The first server 10 can use the tables stored in the first database unit 12 to determine whether the message type data designates that a signal should be generated for transmission to a second server(s) 20, 30 where a second application is to be executed in response to the command from the first client device 11. If so, the first server 10 uses tables stored in its database to identify the second server that is to execute such second application. The first server 10 generates and transmits a message as an XML document including the message type and any attribute(s) to the second server 20 via the network 4. The first server 10 can use encryption key data to encrypt the data within the XML document before transmission over the network 4. The first server 12 can include in the XML document the user name and password identifying the requesting user or the first client device 11 so that the second server 20 can determine whether such user or device is authorized to access the requested application. The first server 10 can also include instructions to the second server 20 as to how to parse the XML document. The second server 20 receives the XML document from the first server 10 via the network 4, determines (optionally) whether the user name and password authorize access to the document. The second server 20 can use instruction data contained within the XML document to determine how to parse such document for the message type and attribute data. If authorized, the second server 20 uses the message type data to retrieve the corresponding second application from its second database storage unit 22. The second server 20 also retrieves second attribute data corresponding to the first attribute data. The second server 20 executes the second application using the second attribute(s). If the message type is such that the second server 20 is to return any result data generated by execution of the second application with the second attribute(s), and execution of the second application produces result data, the second server 20 can generate a display at the second site 2 to prompt a user to indicate whether transmission of the result data to the first server 10 is authorized. If such transmission of result data is not authorized, the second server 20 will not transmit the result data to the first server 10. This measure provides the user of a site with the ability to control access to data hosted at its site. On the other hand, if access to data is authorized, the second server 20 can encrypt the result data and generate and transmit the result data to the first server 10. The first server 10 can transmit this result data as an HTML or XML document to the first client device 11 for generation of a display based on the result data. Optionally, the first and/or second server(s) 10, 20 can store the result data in respective databases 12, 22. Depending upon the nature of the message type data from the first client device 11, the first server 10 can transmit the XML document to an additional site(s) such as the site 3, for processing in a manner similar to that described above with respect to the site 2. The second database storage unit 22 can also store data that can be accessed through insert-data, delete-data, update-data, or send-all data commands. Such data can also result from execution of a second application by the second server 20.

The second database can be complimentary to the first database in terms of the tables stored therein. For example, the second database stored in unit 22 can include message_type_to_application, message_type_to_server, server_URL, first_attribute, second_attribute, . . . , nth_attribute table and attribute_match tables. The message_type_to_application table stores the message type in association with the identity of the second application. The message_type_to_server table maps message type to the identity of the first server 10. The second database storage unit 22 can also store a server_URL table to map the first server identity to its URL. The second database storage unit 22 can also store the attribute_match table that matches first and second attribute(s). The second database storage unit 22 can also store a first_attribute table identifying the attribute(s) used by the first server 10. The unit 22 can store a second_attribute table that identifies attribute(s) used by the second server 20. The unit 22 can store second server application(s) executed by the second server 20 in response to message type data. The unit 22 can also store username/password data, and encryption/decryption keys for use by the second server 20 to encrypt or decrypt data sent to or received from the first server 10 via network 4.

It should be appreciated that a second user of the client device 21 can input a command to execute an application(s). This is essentially the converse process to that described above with respect to a command input by a first user at the first client device 11. More specifically the second user can enter a command including message type and attribute data, generate and transmit the message type and attribute data in an HTML message to the second server 20 via the network 23. The second server 20 receives the message type data and optional attribute(s), determines if the message type data references a second application, and if so, retrieves, loads, and executes the second application optionally with the attribute data. The second server 20 also uses the message type data to refer to the table(s) stored in the second database of the unit 22 to determine if the message type data designates that a first application should also be executed. If so, the second server 20 encrypts the message type and attribute data, generates an XML document including message type and attribute data. The second server 20 can also include user name and password for use by the first server 10 in determining whether access to the first application is permitted. The second server 20 transmits such XML document to the first server 10 via the network 4. The first server 10 receives this XML document and extracts message type and attribute data therefrom. The first server 10 can retrieve the user name and password data, to determine whether the second user or client device 21 is permitted to access the first application server 20 designated by the message type data. The first server 10 uses the received second attribute data to retrieve corresponding first attribute data from the first database stored in unit 12. The first server 10 uses the message type data to retrieve a first server application corresponding to the message type data from the first server's memory. The first server 10 executes the first application using the first attribute data. If the first application is such that result data is generated by its execution, the first server 10 can encrypt such result data, generate an XML document including such result data, and transmit such XML document to the second server 20. The second server 20 receives the result data, and can generate an HTML document to transmit such result data to the second client device 21 for display to the second user. Optionally, the second and/or first server(s) 10, 20 can store result data generated by execution of the application(s) designated by the command from the second client device 21, in respective database(s) of the unit(s) 12, 22.

It should be understood that the message type can designate application(s) and attribute(s) hosted by other sites such as the site 3. The number of application(s) and attribute(s) that may be designated by a request are virtually limitless.

The above-described system has many features that may be advantageous in appropriate circumstances:

(1) users of a site can control access to hosted applications and attribute data designated by requests from other websites. This can be done by controlling access to the application(s) and attribute data for a particular account whose use is authorized only upon verification of a user name/password or cookie, and by prohibiting mappings of message type or attribute data from second sites where access to corresponding applications and attributes is not desired by the site user;

(2) no common system of attributes need be established by all sites of the system. Each site can utilize its own attribute system, and mapping of attributes of different sites can be used to allow meaningful communication between sites. For example, if one site has as attribute “C++ programmer” and another site uses “visual C programmer” as attribute data to describe similar skills of a worker, then a mapping of these attributes can be used to handle command queries involving this attribute. As another example, if one site uses a “truck” to refer to a certain vehicle, and another site uses the attribute “lorry”, a mapping of these two attributes can permit meaningful communication between such sites;

(3) security of messages transmitted within and between sites can be maintained by encryption/decryption schemes; and

(4) the disclosed system permits application(s) and attribute(s) to reside at sites where it normally is hosted, but if an administrator or user at another site requires access to such application(s) or attribute(s), such access can be permitted if the user of such site so authorizes. This eliminates the previously-described disadvantages associated with data-pushing or hub-hosting in previous technologies.

3. The First Server

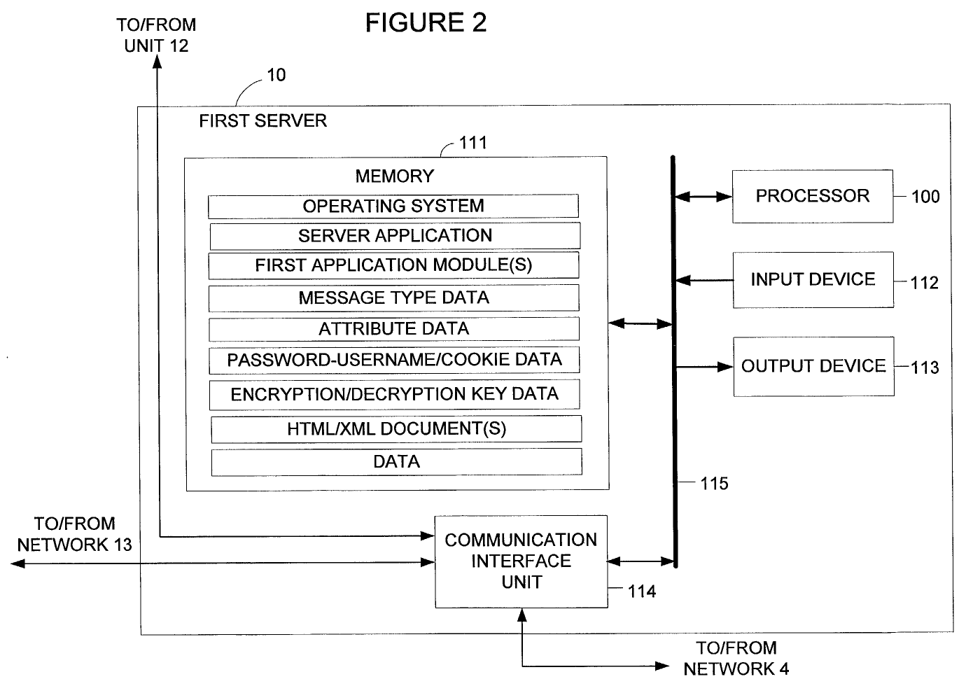

As shown in FIG. 2, the first server 10 can include one or more processors 100, a memory 111, an input device 112, an output device 113, and a communication interface unit 114. The processor 100 is coupled to the memory 111, the input device 112, the output device 113, and the communication interface unit 114 via the bus 115. The processor 100 is also coupled to the first database storage unit 12 via the bus 115. The communication interface unit 114 is coupled to the network 13. The memory 111 stores the operating system executed by the processor 100 to transmit and receive data from the input device 112, output device 113, communication interface unit 114, and the first database storage unit 12. The processor 100 can execute the server application to interact with the first client device 11 over the network 13. The first application module(s) is designated by message type data received from the first client device 11. The first application module(s) is executed by the processor 100 if authorization to access such application is permitted by the first server 10. The communication module permits the processor 100 to generate and transmit XML or HTML documents to and from the first client device 11 and/or first database storage unit 12. The message type data and attribute data is received from the first client device 11 via the network 13 and communication interface unit 114, or from the second server(s) 20, 30, and stored in the memory 111 by the processor 100. The processor 100 can use such message type and attribute data to retrieve data from the first database storage unit 12 and to request execution of a second application via second servers 20, 30. The password-username or cookie data stored in the memory 111 permits the processor 100 to determine whether the user and/or first client device 11 is authorized to access an application requested by such user or first client device. The encryption/decryption key data can be used by the processor 100 to encrypt and/or decrypt data sent to or received from the first client device 12 and/or the second server(s) 20, 30. The first server 10 can store HTML or XML documents, forms or posts generated by the processor 100 in execution of the server application and/or first application module(s), and/or received from the first client device 11 and/or second server(s) 20, 30. The input device 112 and output device 113 can be used by an operator or system administrator to install and maintain the software, data, and hardware of the first server 10.

4. First Client Device

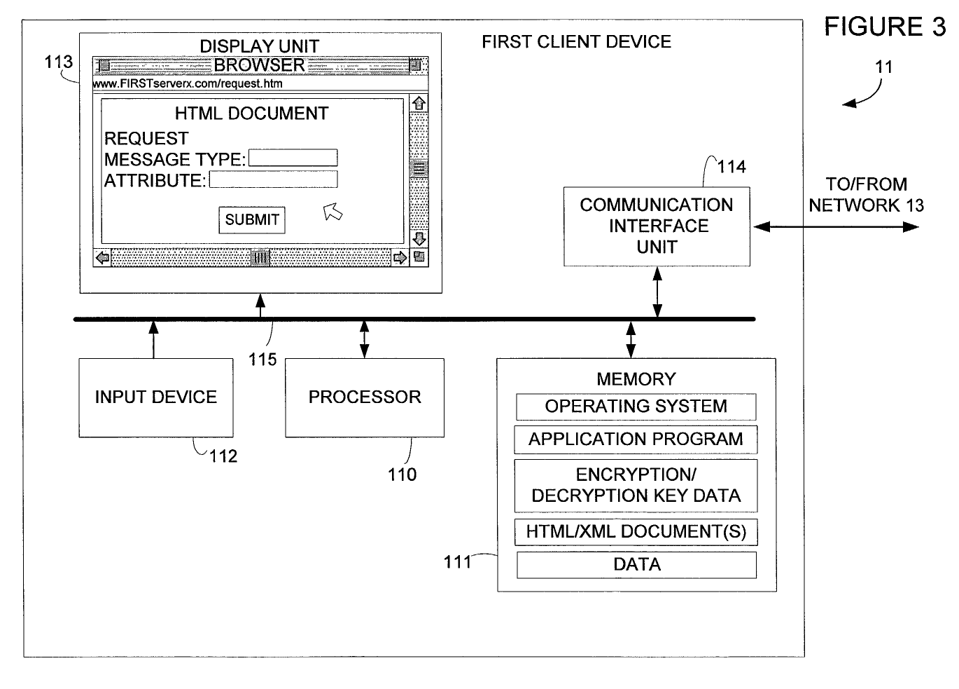

As shown in FIG. 3, the first client device 11 can include a processor 110, a memory 111, an input device 112, a display unit 113, a communication interface unit 114, and a bus 115. The processor 110 can be coupled via the bus 115 to the memory 111 , the input device 112, the output device 113, and the communication interface unit 114. The communication interface unit 114 can be coupled to the first server 10 via the network 13. The memory 111 can store various software and data such as the operating system, the application program, the communication module, HTML and/or XML documents, encryption/decryption key data, and other data. The processor 110 can execute the operating system stored in the memory 111 to permit the processor to communicate with the input device 112, the display unit 113, and the communication interface unit 114. The processor 110 can execute the application program stored in the memory 111 that can be a browser or other client program, for example, for interacting with a server application of the first server 10. The processor 110 can also execute its application program to transmit data such as the message type and attribute to the first server 10, as well as to receive result data from the first server 10, in hypertext transport protocol (HTTP) or other communication protocol. The HTML or XML documents, forms or posts stored in the memory 111 can be generated by the processor 110 in the execution of its application program, or can be generated by the first and/or second server(s) 10, 20, 30 and received via the communication interface unit 114. The processor 110 can also store or retrieve other data, such as temporary data generated by such processor in execution of one of the programs stored in its memory 111, or received from the first server 10.

As shown in FIG. 3, the processor 110 of the first client device 11 can execute script in an HTML or XML document, form, or post to produce a display on the display unit 113. The HTML or XML form shown in FIG. 3 prompts the user to input a command in the message type field, and attribute(s) associated with that message type. The user can manipulate the input device 112 to move the cursor over the submit button and activate such button to post the message type and attribute data to the first server 111. In response to activation of the input device 112, the processor 110 receives and optionally encrypts the message type and attribute data using the encryption key data stored in the memory 111. The processor 110 generates and transmits an HTTP message including the encrypted message type and attribute data to the first server 10 via the communication interface unit 114 and the network 13. The processor 110 can receive result data if any result from execution of the application designated by the message type data entered by the first user, use the decryption key data stored in the memory 111 to decrypt the result data, and generate a display on the display unit 113 to provide a visual display of the result data to the user. The processor 110 can also store the received result data in its memory 111 for later retrieval by the first user, for example.

5. First Database Storage Unit

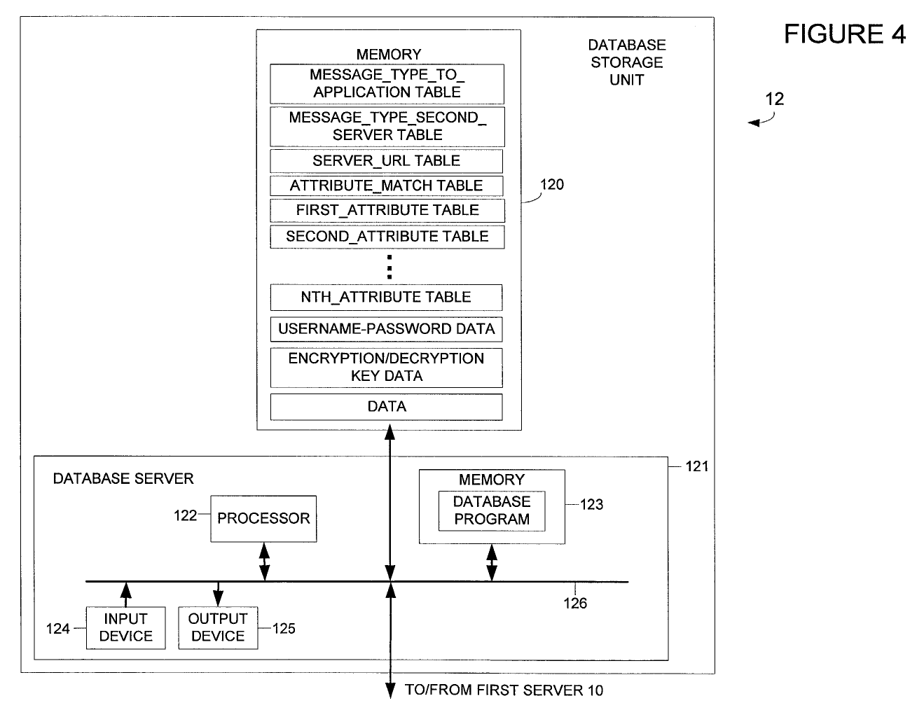

As shown in FIG. 4, the database storage unit 12 can include a memory 120 and a database server 121. The database server 121 is coupled to the first server to handle queries for data and requests to insert, delete, or modify data or records. The database server 121 is coupled to the memory 120 to transmit and receive control and address signals and data to and from the memory 120. The database server 121 includes a processor 122, a memory 123, an input device 124, and an output device 125. The database server receives and handles requests to create, insert, delete, or modify data or data records stored in the memory 120. To perform these functions, the processor 122 can execute a database program stored in the memory 123. The database server 121 can include an input device 124 and output device 125 to provide a graphical user interface that an operator or user can manipulate to interact with the processor 122. For example, the input device 124 and output device 125 can be operated to store or modify the database program or data such as the message type, attribute, account, user name-password, cookie, encryption/decryption key data, server or client URLs, or data resulting from execution of the first application(s) and/or stored for access by the insert-data, delete-data, update-data, or synchronize-data commands. The input device 124 and output device 125 can be used to create, insert, delete or modify mappings between first and second attributes, for example. The devices 124, 125 can also be used to store, delete, or modify application program(s), and other data and/or programs stored in the memory 120.

The database server 121, or more specifically the processor 122 executing the database program, can perform several functions. For example, the database server 121 can receive a signal from the first server 10 requesting identification of an application associated with a message type. In response to this request signal, the database server 121 can generate a query to obtain the identification of a first application module (if any) associated with the message type data. The database server 121 can respond to the first server 10 with the identification data for the first application module corresponding to the message type data. The first server 10 can use the data identifying the first application module to retrieve, load, and execute such module. Further, upon request from the first server 10, the database server 121 can retrieve and supply the first server 10 with the URL of a second server(s) designated by the message type data to execute a second application(s). The first server can also translate second attribute(s) into first attribute(s) to respond to requests from second server(s) involving such attribute(s). The database server 121 can also retrieve user name and password or cookie data to establish authorization of the first or second user(s) or device(s) to access an application. The database server 121 can also respond to a request from the first server 10 to provide encryption/decryption data for a user or device account.

6. Second Sites

The second site(s) 2-N can have respective second server(s), second client device(s), and second database storage unit(s) constructed and functioning similarly to the first server 10, the first client device 11, and the first database storage unit 12, respectively, of the first site 1. The mapping of second to first attribute(s) is stored in the second database(s) so that the second server(s) can request resource(s) of the first server using in terms of first attribute(s) native to such first server. In addition, the second database(s) can store the URL of the first server 10 to permit the second server(s) to request that the first server to execute a first application(s), and optionally return result data to the second server(s). If password-username are used, this data can be synchronized with the second server(s) 20, 30 to enable such server(s) to determine whether requests from the first server 10 are authorized. In addition, the encryption/decryption data used by the first server 10 and the second server(s) 20, 30 is generally established to permit secure communication between the first and second servers via the network 4.

7. Method to Prepare First and Second Databases for Interactivity and to Share Data

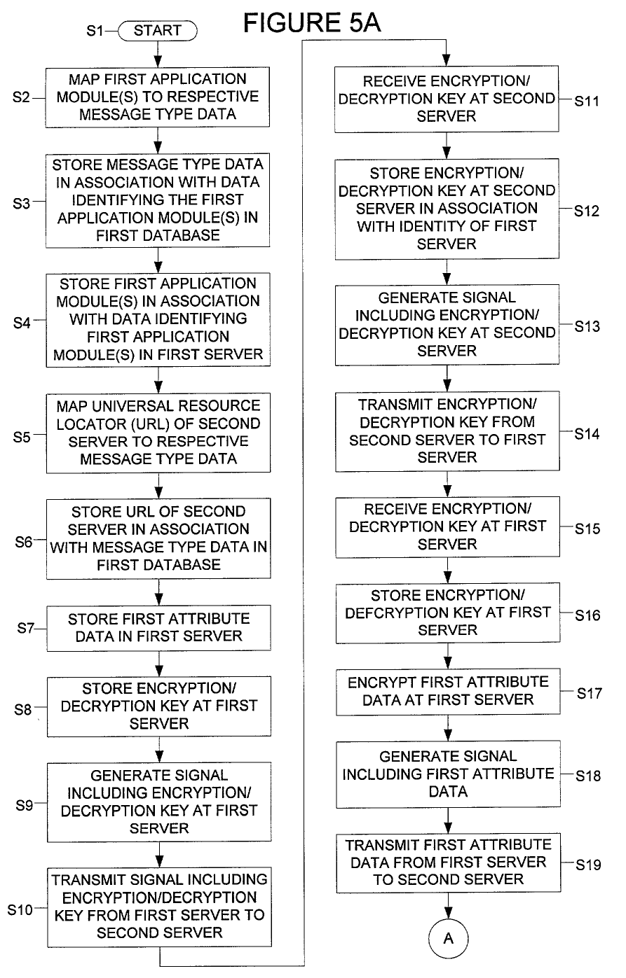

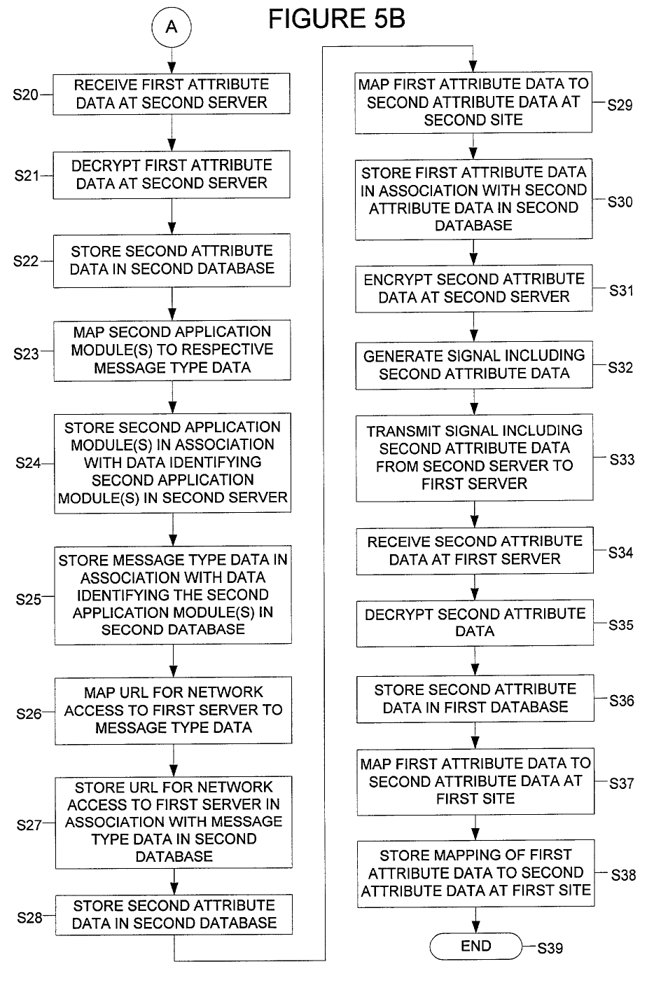

In FIG. 5A, the method of preparing the first and second databases to permit communication between respective servers begins in step S1. In step S2, the first application module(s) are mapped to respective message type data. This step is generally carried out by a programmer familiar with the application module(s) at the first site 1. For example, the message type data can include insert-attribute, update-attribute, delete-attribute, synchronize-all-attribute, insert-data, update-data, remove-data, or send-all-data commands that are carried out by respective first application modules. In step S3, the message type data is stored in association with data identifying the first application module, in the first database in the unit 12 by the first server 10. In step S5, URL(s) for secured access via the network 4 to second server(s) 20, 30, are mapped to respective message type data. This step is generally performed by a system administrator at the first site 10. For example, the update-data or send-all-data commands can be mapped to URLs if the update would be useful for the second databases or result data sought resides in the second databases 22, 32. In step S6, the URL(s) of the second server(s) are stored in association with respective message type data in the first database stored in the unit 12. In step S7, first attribute data is stored in the database storage unit 12. This step can be performed by a system administrator at the first site 1, for example. In step S8 the first server 10 stores encryption/decryption key data in the unit 12. Such encryption/decryption key data can be input by a system administrator. In step S9 the first server 10 generates a signal including the encryption/decryption key data. In step S10 the first server 10 transmits the signal including the encryption/decryption key data from the first server 10 to the second server(s) 20, 30 via the network 4. In step S1 the second server(s) 20, 30 receives the encryption/decryption data at the second server(s) 20, 30. In step S12 the second server(s) 20, 30 stores the encryption/decryption data in association with the identity of the first server 10. In step S13 the second server(s) 20, 30 generate a signal including encryption/decryption key data. In step S14 the second server(s) 20, 30 transmit the encryption/decryption key data at the second server(s) 20, 30. In step S15 the first server 10 receives the encryption/decryption data at the first server 10. In step S16 the first server 10 stores the encryption/decryption data in the first database storage unit 12 in association with data identifying the second server(s) 20, 30. In step S17 the first server 10 encrypts first attribute data at the first server 10. In step S18 the first server 10 generates a signal including the first attribute data. In step S19 the first server 10 transmits the first attribute data from the first server 10 to the second server(s) 20, 30 via the network 4. In step S20 of FIG. 5B the second server(s) 20, 30 receives the first attribute data form the first server 10. In step S21 the second server(s) 20, 30 decrypts the first attribute data at the second server(s) 20, 30 using the decryption key data corresponding to the first server 10. In step S22 the second server(s) 20, 30 store second attribute data in the second database of units 22, 32. The second attribute data can be input by a user at the second site, for example. In step S23 the second application module(s) are mapped to respective message type data. In step S25 the message type data is stored in association with data identifying the second application module(s) in the second database in the unit 12. In step S26 the URL for network access to the first server 10 is mapped to respective message type data. In step S27 the second server(s) 20, 30 store the URL for network access to the first server 10 in association with respective message type data in the second database(s) in the unit(s) 22, 32. In step S28 the second server(s) 20, 30 stores second attribute data in the second database(s) of the unit(s) 22, 32. In step S29 the first attribute data is mapped to second attribute data at the second site(s). This step can be performed by a person having knowledge of the first and second attribute data and their relation. This step can also be performed with the assistance of one of numerous indexing or search engines that can be used to rank each second attribute data with respect to the relative closeness to the first attribute data. A skilled person can review matches between first and second attributes to determine whether such matchings are correct or desired. Such skilled person can also change second and first attribute matchings as desired for accurate mappings or to prevent access to certain data associated with the attribute(s), for example. In step S30, the second attribute data is stored in the first database in association with the first attribute data mapped thereto in the previous step. In step S31 the second server(s) 20, 30 encrypts the second attribute data. In step S32 the second server(s) 20, 30 generates a signal including second attribute data. In step S33 the second server(s) 20, 30 transmits the signal including the second attribute data to the first server 10 via the network 4. In step S34 the first server 10 receives the second attribute data from the second server(s) 20, 30. In step S35 the first server 10 decrypts the second attribute data using the appropriate decryption key. In step S36 the first server 10 stores the second attribute data in the first a database of the unit 12. In step S37 the first server 10 maps the first attribute data to the second attribute data. The first server 10 can use one of numerous index and/or search engine(s) to assist in the performance of this step. In step S38 the first server 10 stores the association of the first and second attribute data in the unit 12. In step S39 the method of FIGS. 5A and 5B ends.

8. General Method and Operation of the System

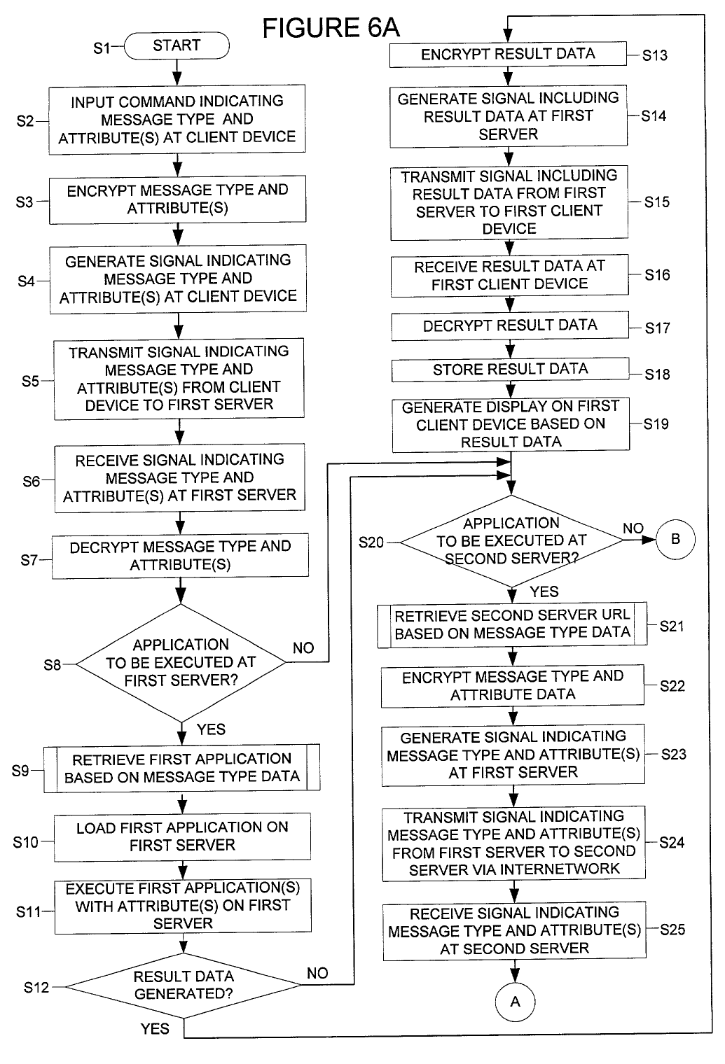

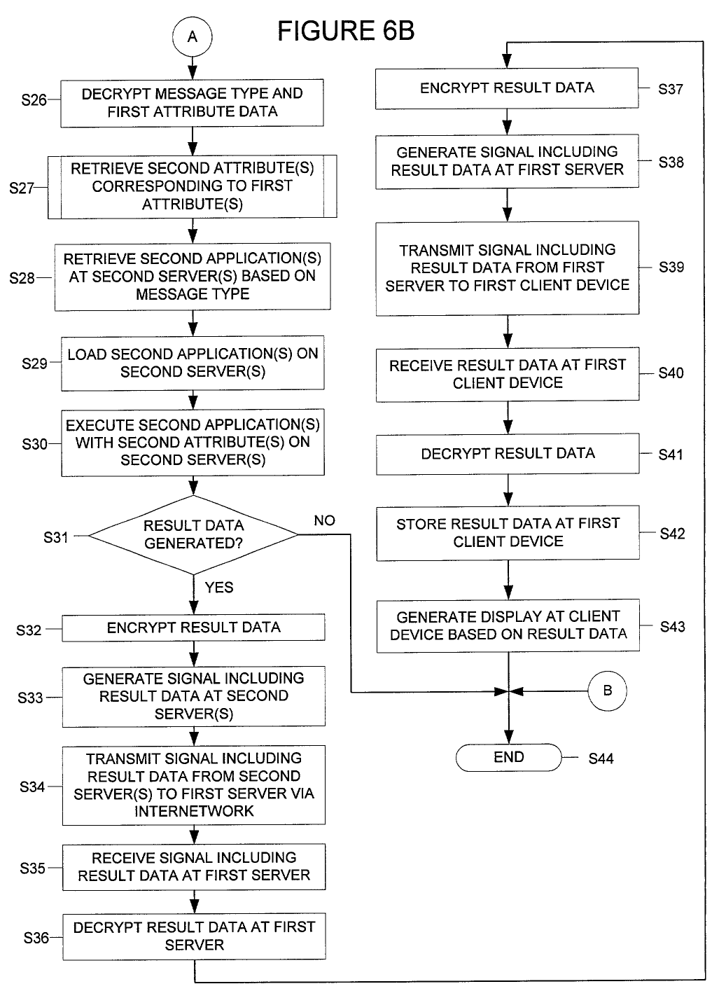

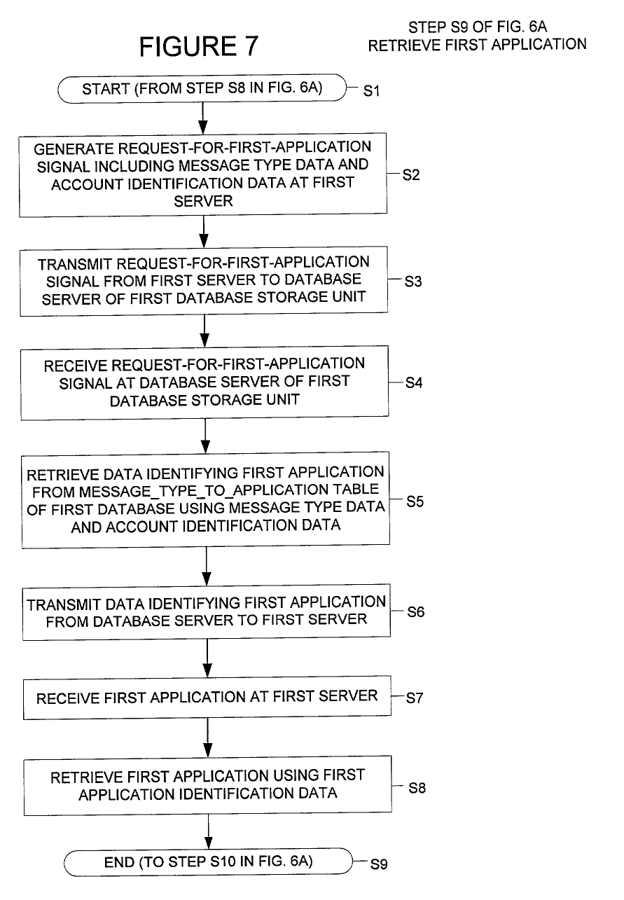

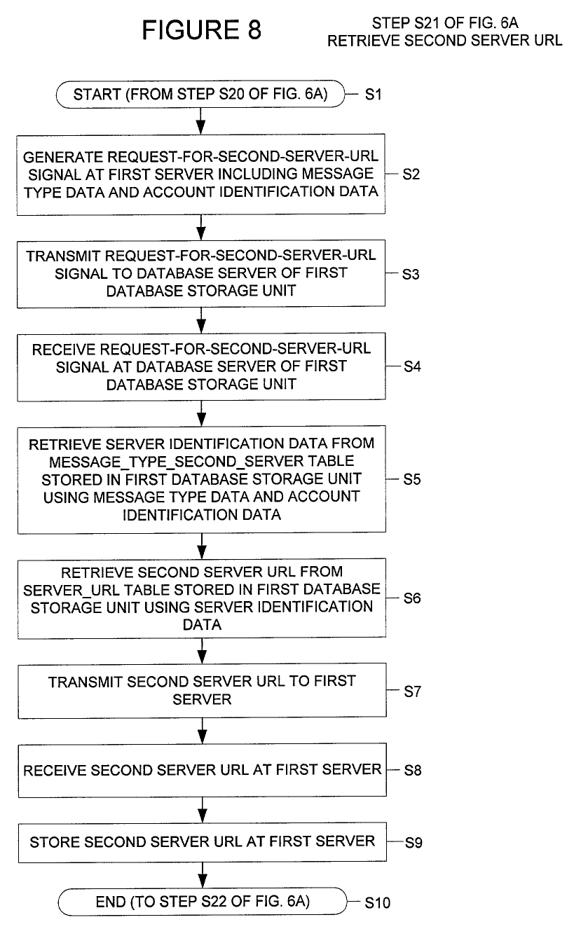

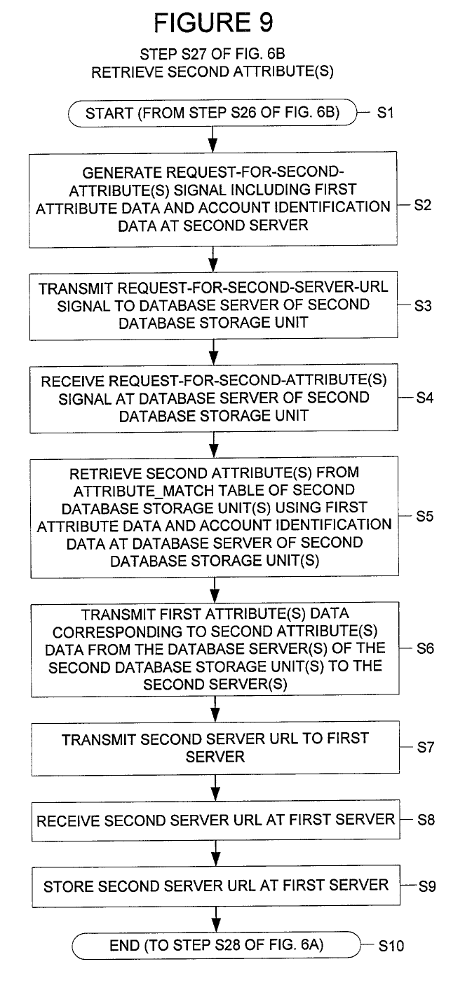

A general method corresponding to the operation of the disclosed system is now described. The method can be executed by the processors of the client device(s) and server(s) of the sites of the system. In step S1 of FIG. 6A the method begins. In step S2 the first user inputs a command that indicates the message type and attribute data using the first client device 11. In step S3, the first client device 10 encrypts the message type and attribute data. This step is optional and may be omitted. In step S4 the first client device 11 generates a signal indicating the message type and attribute(s). In step S5 the first client device 11 transmits the signal indicating the message type and attribute(s) from the first client device 11 to the first server 10. The first client device 11 can transmit the signal to the first server 10 via the network 13. In step S6 the first server 10 receives the signal indicating the message type and attribute(s) at the first server 10. In step S7 the first server 10 decrypts the message type and attribute data contained within the received signal. In step S8 the first server 10 determines whether the received message type indicates that a first application is to be executed by the first server 10. If so, in step S9 the first server 10 retrieves the first application from the first database storage unit 12 based on the message type data. In step S10 the first server 10 loads the first application. In step S11 the first server 10 executes the first application with first attribute(s) on the first server 10. In step S12 the first server 10 determines whether execution of the first application has produced result data. If so, in step S13 the first server 10 encrypts the result data. In step S14 the first server 10 generates a signal including the encrypted result data. In step S15 the first server 10 transmits the signal including the result data from the first server 10 to the first client device 11. In step S17 the first client device 10 decrypts the result data. In step S18 the first client device 11 stores the result data in its memory. In step S19 the first client device 10 generates a display based on the result data. Proceeding from step S19, or if the determinations in step S8 or S12 are negative, in step S21 the first server 10 determines whether the message type data indicates that a second application(s) is to be executed. Such determination can be made by the first server 10 through the execution of the first application which is coded to indicate whether a second application(s) is to be executed. Alternatively, the first server 10 can retrieve data from the first database storage unit 12 for use in making this determination. If the determination in step S20 is affirmative, in step S21 the first server 10 retrieves the second server URL using the message type data. In step S22 the first server 10 retrieves encryption key data from the first database stored in the unit 12, and uses such key to encrypt the message type and attribute data. In step S23 the first server 10 generates a signal including the message type and attribute(s) at the first server. In step S24 the first server 10 transmits the signal including the message type and attribute(s) data from the local server 10 to the second server(s) 20, 30 via the network 4. The first server 10 can use the second server URL retrieved in step S21 to transmit the signal including the message type and attribute(s) data to the second server(s) 20, 30. In step S26 of FIG. 6B the second server(s) 20, 30 receives the signal indicating the message type and first attribute(s) data from the first server 10 via the network 4. In step S26 of FIG. 6B the second server(s) 20, 30 decrypts the message type and first attribute data. In step S27 the second server(s) 20, 30 retrieves second attribute(s) corresponding to the first attribute(s). In step S28 the second server(s) 20, 30 retrieves the second application(s) corresponding the message type received from the first server 10. In step S29 the second server(s) 20, 30 loads the second application(s). In step S30 the second server(s) 20, 30 executes the second application(s) using second attribute(s). In step S31 the second server(s) 20, 30 determines whether result data that is to be returned to the first server 10 has been generated by execution of the second application(s). If so, in step S32 the second server(s) encrypts the result data. In step S33 the second server(s) 20, 30 generates a signal including the result data. In step S34 the second server(s) 20, 30 transmits the signal including the result data from the second server(s) to the first server 10. The second server(s) 20, 30 can transmit the signal including the result data to the first server 10 via the network 4. In step S35 the first server receives the signal including the result data from the second server(s) 20, 30 via the network 4. In step S36 the first server 10 decrypts the result data from the second server(s) 20, 30. The first server 10 can retrieve a decryption key from the database storage unit 12 to decrypt the result data. In step S37 the first server 10 encrypts the result data in accordance with the security procedure established between the first client device 11 and the first server 10. The first server 10 retrieves from its memory an encryption key from the first database storage unit 12 for use in encrypting the result data. In step S38 the first server 10 generates a signal including the encrypted result data. In step S39 the first server 10 transmits the signal including the result data from the first server to the first client device 11. The first server 10 can transmit the signal including the encrypted result data to the first client device 10 via the network 13. In step S40 the first client device 11 receives the result data from the first server 10. In step S41 the first client device 11 retrieves decryption key data from its memory, and decrypts the result data. In step S42 the first client device 11 stores the result data in its memory. In step S43 the first client device 11 generates a display based on the result data. The first user can thus view result data resulting from execution of the second application(s).

FIG. 7 is a flowchart of a subroutine that corresponds to step S9 of FIG. 6A in which a first application is retrieved by the first server 10 from the first database. The flowchart of FIG. 7 corresponds to processing performed by the processors of the first server and the database server to retrieve the first application from the first database storage unit 12. In step S1 the method of FIG. 7 begins. In step S2 the first server 10 generates a request for first application signal including message type data and optionally account identification data. The account identification data can be established by the user name and password or cookie data, for example. In step S3 the first server 10 transmits the request-for-first-application signal to the database server 121 of the first database storage unit 12. In step S4 the database server 121 receives the request-for-first-application signal from the first server 10. In step S5 the database server 121 retrieves the data identifying the first application from the message_type_to_application table stored in the first database, using the message type data and the account data included in the request-for-first-application signal. In step S7 the database server 121 transmits the first application to the first server 10. In step S8 the first server 10 receives the first application from the database server 121. In step S9 the first server 10 stores the first application in its memory. In step S10 the method of FIG. 7 terminates and returns to step S10 of FIG. 6A.

FIG. 8 is a flowchart of a subroutine that corresponds to step S21 of FIG. 6A. The method begins in step S1 of FIG. 8. In step S2 the first server 10 generates a request-for-second-server-URL signal including message type data and account identification data. In step S3 the first server 10 transmits the request-for-second-server-URL signal to the database server 121 of the first database storage unit 12. In step S4 the database server 121 of the first database storage unit 12 receives the request-for-second-server-URL signal from the first server 10. In step S5 the database server 121 retrieves the server identification data from the message_type_to_server table stored in the first database storage unit 12 based on the message type data and optionally also in the account identification data. In step S6 the database server 121 retrieves the second server URL from the server_URL table stored in the first database storage unit 12 using the server identification data. In step S7 the database server transmits the second server URL to the first server 10. In step S8 the first server receives the second server URL from the database server 121. In step S9 the first server 10 stores the second server URL in its memory. In step S10 the method of FIG. 8 ends and returns to step S22 of FIG. 6A.

FIG. 9 is a flowchart of a subroutine that corresponds to step S27 of FIG. 6B. In step S1 the method of FIG. 9 begins. In step S2 the second server(s) 20, 30 generates a request-for-second-attribute(s) signal including first attribute data and account identification data. In step S3 the second server(s) 20, 30 transmits the request-for-second-attribute(s) signal to the database server(s) of the second database storage units 22, 32. In step S4 the database server(s) of the unit(s) 22, 32 receives the request-for-second-attribute(s) signal from the second server(s) 20, 30. In step S5 the database server(s) of the unit(s) 22, 32 retrieve second attribute(s) from the second database storage based on the first attribute(s) and the account identification data. In step S6 the database server(s) of the unit(s) 22, 32 transmit second attribute data corresponding to the first attribute(s) from the database server(s) of the second database storage unit(s) to the second server(s) 20, 30. In step S7 the second server(s) 20, 30 receive the second attribute data from the database server(s) of the unit(s) 22, 32. In step S8 the second server(s) 20, 30 stores the second attribute data. In step S9 the method of FIG. 9 ends.

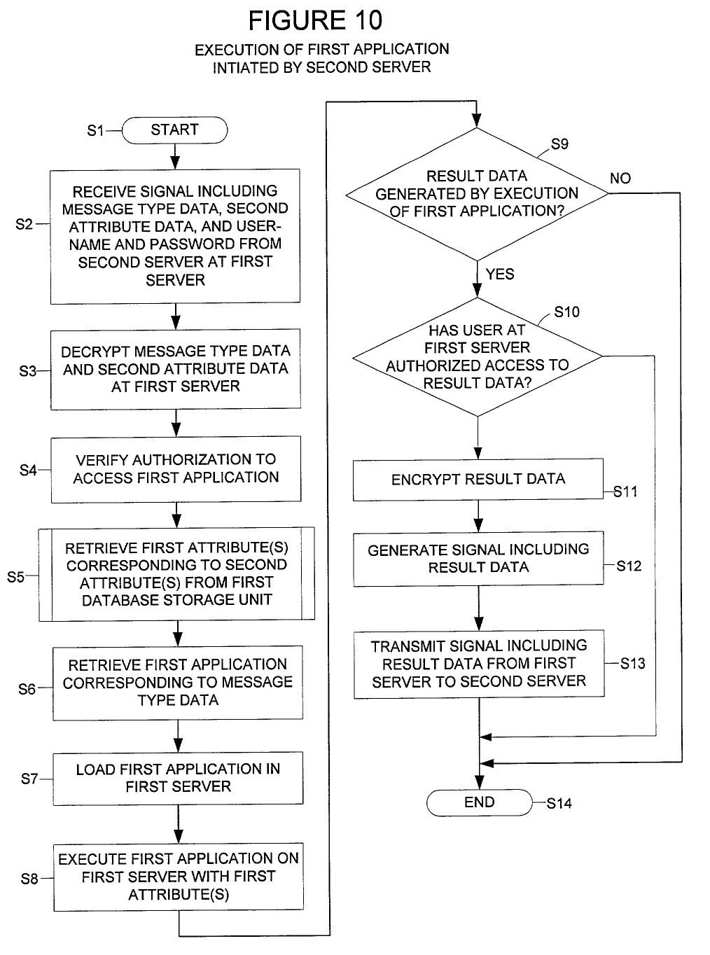

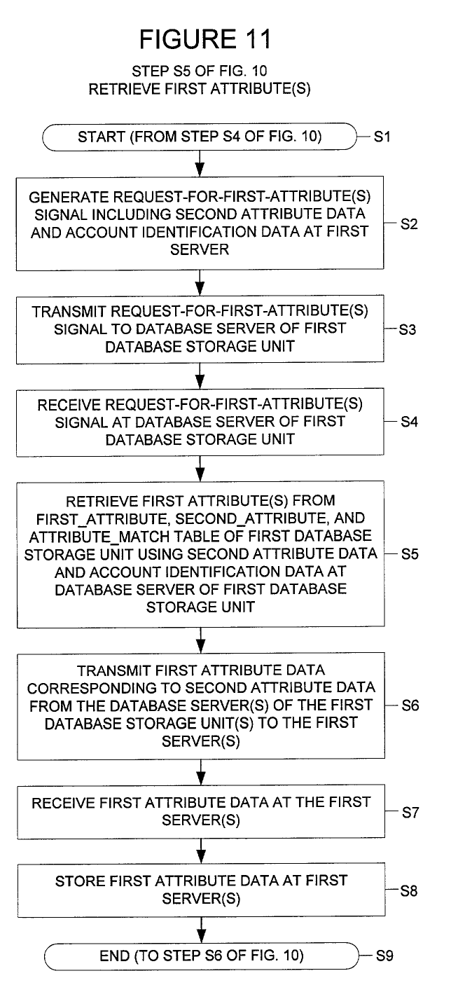

FIG. 10 is a flowchart indicating how the first server 10 can be programmed to respond to requests for execution of a first application and optionally to transmit result data resulting from execution of such first application to the second server. In step S1 the method of FIG. 10 begins. In step S2 the first server 10 receives a signal including message type data and second attribute data from the second server(s) 20, 30 via the network 4. In step S3 the first server 10 decrypts the message type data and second attribute data included in the received signal. In step S4 the first server 10 verifies authorization to determine whether the second user or second client device initiating the request is authorized to request execution of the first application. The first server 10 can perform this verification based on user-name and password and/or an account associated therewith, for example, to verify authorization of the second server's request. If authorization to comply with the second server's request cannot be verified, the first server 10 rejects the request. Assuming that the first server 10 verifies authorization of the second server's request, in step S5 the first server 10 retrieves first attribute(s) corresponding to the second attribute(s) from the first database storage unit 12. In step S6 the first server 10 retrieves from the first database storage unit 12 the first application corresponding to the message type data in the request signal from the second server(s) 20, 30. In step S7 the first server 10 loads the first application. In step S8 the first server 10 executes the first application using the first attribute(s) corresponding to the second attribute(s). In step S9 the first server 10 determines whether execution of the first application with the first attribute(s) has produced result data requested by the second server(s) 20, 30. If so, in step S10 the first server 10 encrypts the result data using an encryption key appropriate for the second server(s) 20, 30. In step S11 the first server 10 generates a signal including the result data. In step S12 the first server 10 transmits the signal including the result data to the second server(s) 20, 30. The first server 10 can transmit the signal including the result data to the second server(s) 20, 30 via the network 4. In step S13 the method of FIG. 10 terminates.

FIG. 11 is a flowchart of a subroutine that corresponds to step S5 of FIG. 10. In step S1 the method of FIG. 11 begins. In step S2 the first server 10 generates a request-for-first attribute(s) signal including second attribute data and optionally including account identification data. In step S3 the first server 10 transmits the request-for-first-attribute(s) signal to the database server 121 of the first database storage unit 12. In step S4 the first server 10 receives the request-for-first-attribute(s) signal at the database server 121 of the first database storage unit 12. In step S5 the database server 121 retrieves first attribute(s) from the first_attribute, second_attribute, and attribute_match table of the first database storage unit 12 using the second attribute data. The database server 121 can also retrieve the first attribute data based on account identification data that identifies the person, business, or organization to which the request signal pertains. In step S6 the database server 121 of the first database storage unit 12 transmits the first attribute data corresponding to the second attribute data, to the first server 10. In step S7 the first server 10 receives the first attribute data from the database server 121. In step S7 the first server 10 stores the first attribute data in its memory. In step S9 the method of FIG. 11 ends and returns to step S6 of FIG. 10.

9. Methods for Producing the Attribute_Match Table

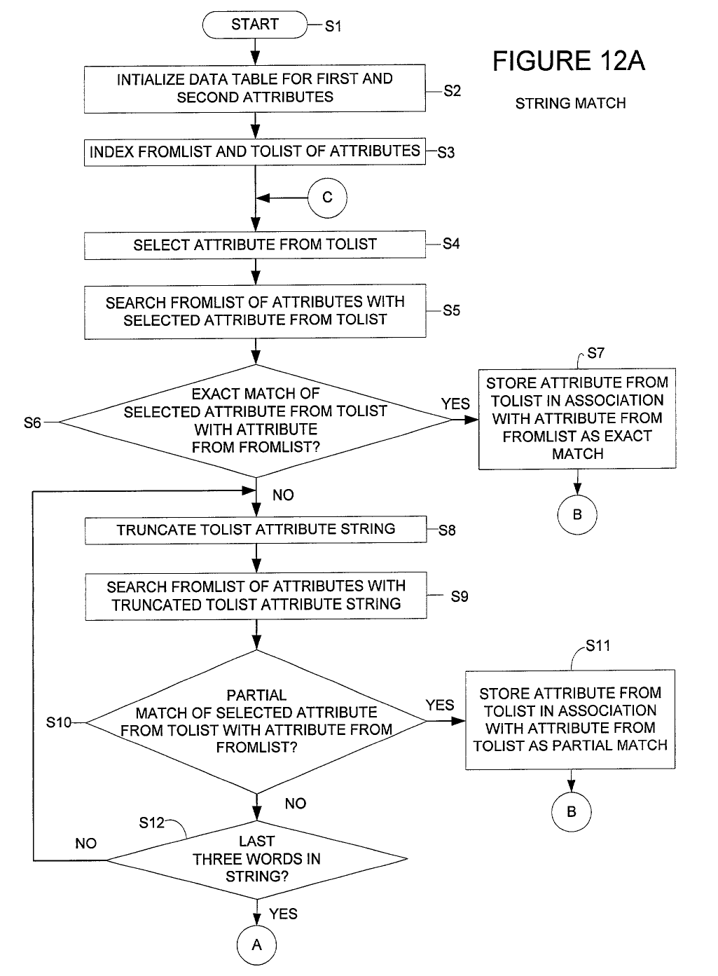

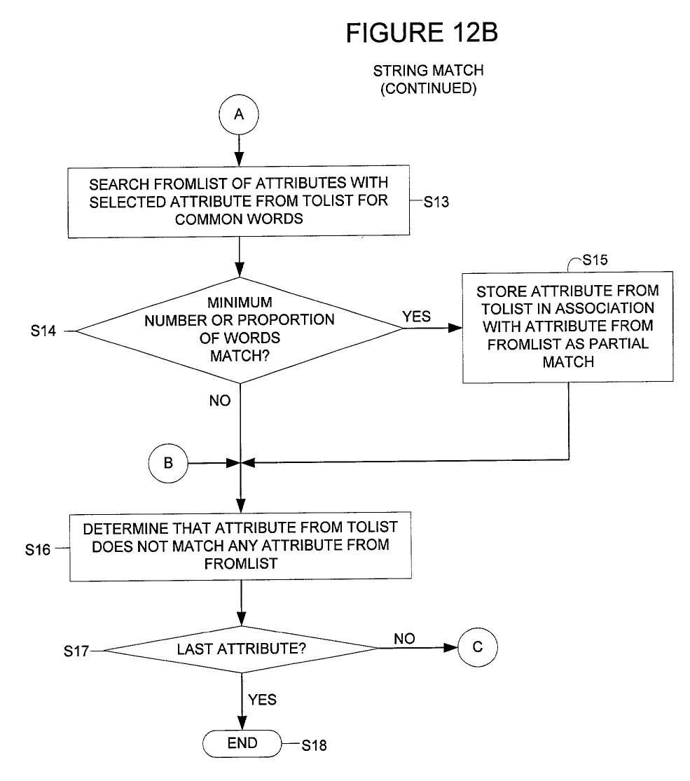

The following description explains how the first server 10 and/or second server(s) 20, 30 and respective database server(s), or more specifically the processors thereof, can match first and second attributes. In step S1 of FIG. 12A the method of FIGS. 12A and 12B begins. In step S2 the data table for the attribute_match table is initialized by the database server under request from the respective first or second server(s) of the site at which this table is maintained. In step S3 the fromlist of attributes is indexed. The fromlist is the list of attributes from which matches are taken by the first or second server(s) uses, i.e., the second attribute(s) stored in the second_attribute table in the case of the first server 10, and the first attribute(s) stored in the first_attribute table in the case of the second server(s) 20, 30. “Indexing” or “normalizing” the first or second attribute(s) can be used to make such attribute(s) more readily searched such as by making any upper case characters lower case, removing punctuation, hyphens, and the like, inserting any spaces needed to delineate different words of the attribute, etc. The indexing or normalizing operation eliminates features and characters in the string of the attribute(s) that may prevent matching of otherwise similar attributes. The “normalizing” operation also renders the attribute character string more readily searchable by eliminating character(s) that do not distinguish the identity of the attribute(s). In general, attribute(s) of any length of character(s) or word(s) can be matched. However, attribute(s) more than three character words in length can be required for a match because it has been found that attribute matchings below this limit are not necessarily reliable. In step S4 the first or second server(s) selects an attribute from the tolist. The tolist is a list of attribute(s) to which matchings are to be made of the attribute(s) used by the server performing the method. Hence, for the first server, the attributes in the tolist are contained in the second_attribute table, and for the second server(s) these attribute(s) are the first attribute(s) stored in the first_attribute table. In step S5 the first or second server(s) search the fromlist for an exact match of the selected attribute from the tolist. If a match is determined, in step S7 the first or second server(s) stores the attribute from the tolist in association with the corresponding attribute from the fromlist in the attribute_match table. On the other hand, if the determination in step S6 is negative, in step S8 the first or second server(s) executing the method truncate the tolist attribute string. This can be done by eliminating the last character word in the string. In step S9 the first or second server(s) search the fromlist of attribute(s) with the truncated attribute from the tolist attribute string. In step S10 the first or second server(s) executing the method determines whether a partial match of the selected attribute from the fromlist has been found from the tolist. If so, in step S11 the first or second server(s) executing the method stores the attribute from the tolist in association with the attribute from the fromlist in the attribute_match table at the server's site. On the other hand, if the determination in step S10 is negative, in step S12 the first or second server(s) executing the method determines whether the attribute string has been truncated to the last three words of the string. If not, the first server or second server executing the method returns to step S8 to repeat truncation of the attribute string from the tolist. On the other hand, if the determination in step S12 is affirmative, the first or second server executing the method proceeds to step S13 of FIG. 12B. In step S13 the first or second server(s) executing the method searches the fromlist of attribute(s) with the selected attribute from the tolist for common character words. The first or second server(s) executing the method determines in step S14 whether a minimum number for words match and/or whether a minimum proportion of matching words to total words in the attribute from the fromlist or tolist or the average thereof, has been reached. If so, in step S15 the first or second server(s) stores the attribute from the tolist in association with the attribute(s) from the fromlist. On the other hand, if the determination in step S14 is negative, in step S16 the first or second server(s) determines that the attribute from the tolist does not match any attribute from the fromlist. Data indicating the fact that no match has been found can be stored in the attribute_match table. However, storing data indicating no attribute match is generally not necessary from the standpoint that the absence of a mapping of a first attribute to a second attribute in the attribute_match table conveys this information. In step S17 the first or second server(s) performing the method determines whether the last attribute in the fromlist has been matched to the tolist. If not, the first or second server(s) performing the method return to step S4. On the other hand, if the determination in step S17 is affirmative, processing of the method of FIGS. 12A and 12B performed by the first or second server(s) and database server(s) terminates in step S18.

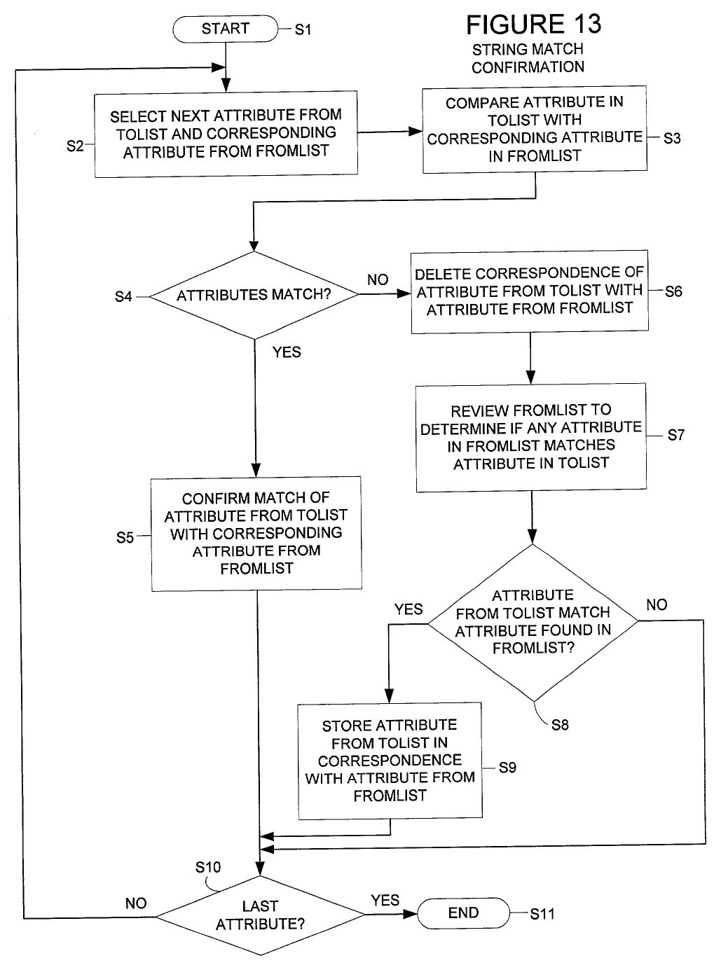

FIG. 13 is a flowchart of steps performed by a person(s) familiar with the first and second attribute(s) to confirm accuracy of the mapping of the attribute_match table generated by the first or second server(s). In step S1 the method of FIG. 13 begins. In step S2 of FIG. 13 the person selects the next attribute from the tolist and corresponding attribute from the fromlist. In step S3 the person compares the attribute in the tolist with the corresponding attribute in the fromlist. In step S4 the person uses his or her knowledge of the attributes to determine whether the attributes from the tolist and fromlist match. If so, in step S5 the person confirms the match of attributes from the tolist and fromlist. On the other hand, if the determination in step S4 is affirmative, in step S6 the person uses the input device(s)/output device(s) of the first or second server(s) and/or database server(s) to delete the correspondence of attribute(s) from the tolist and fromlist. In step S7 the person reviews the fromlist to determine if any attribute in the fromlist matches the attribute in the tolist. In step S8 the person determines whether the attribute from the tolist matches any attribute(s) in the fromlist. If so, in step S9 the person operates the first or second server(s) and/or database server(s) to store the matching attribute from the tolist in correspondence with the attribute from the fromlist. After performance of step S9 or if the determination in step S8 is negative, in step S10 the person determines whether the last of the first and second attributes stored in the attribute_match table have been checked. If not, the method of FIG. 13 returns to step S2. On the other hand, if the determination in step S10 is affirmative, in step S11 the method of FIG. 13 ends.

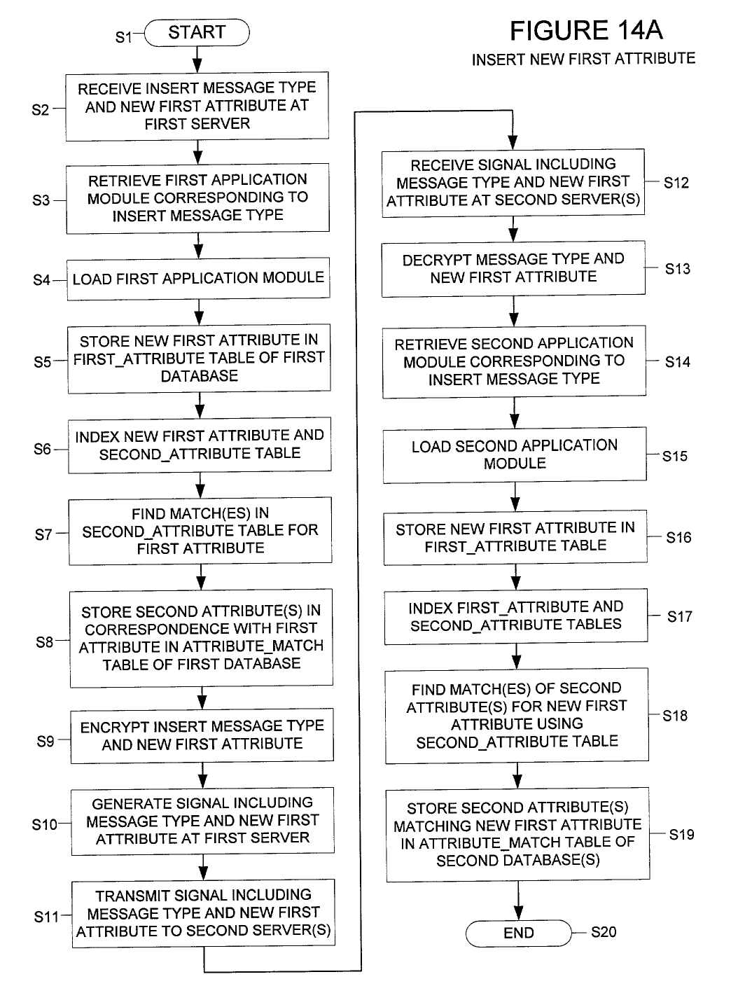

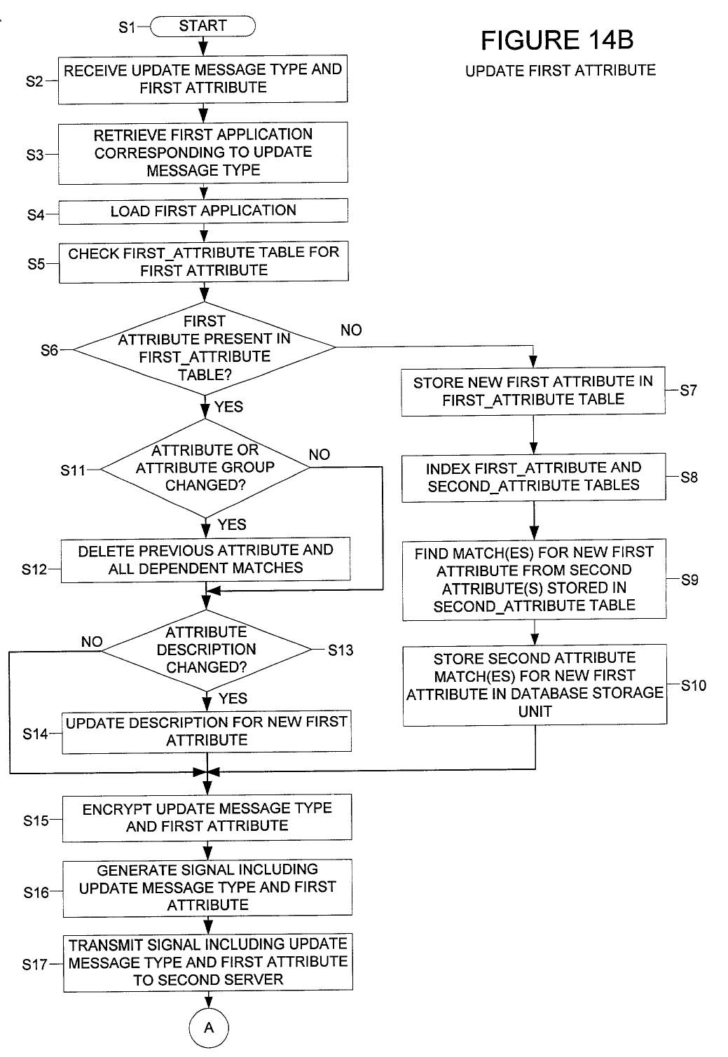

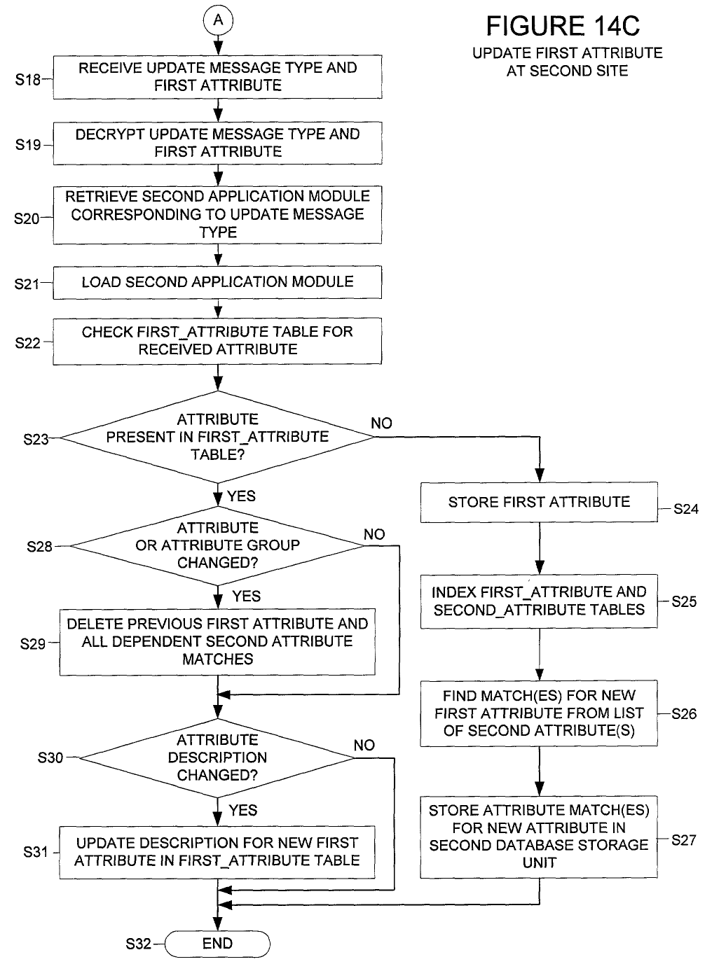

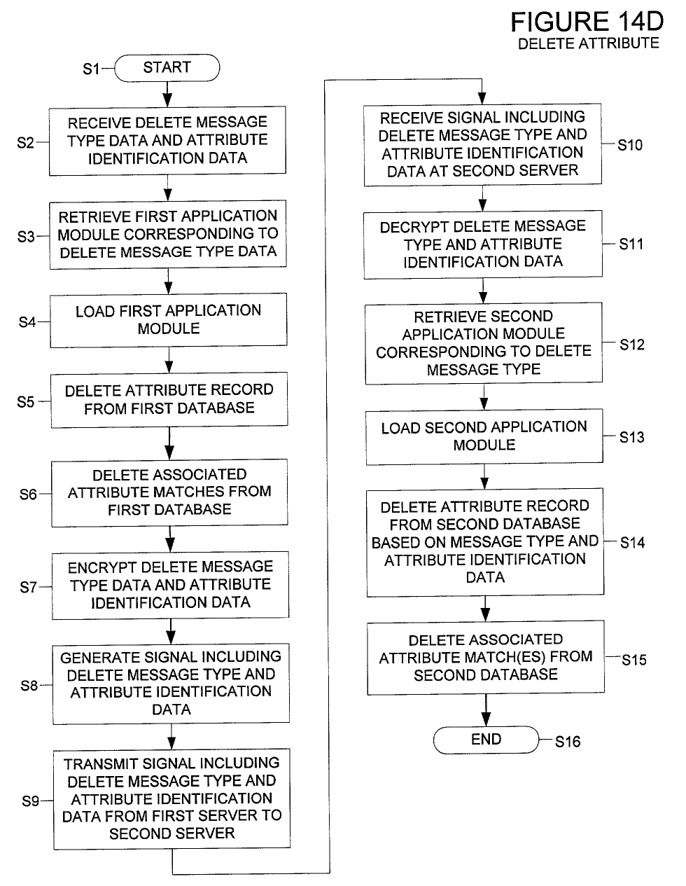

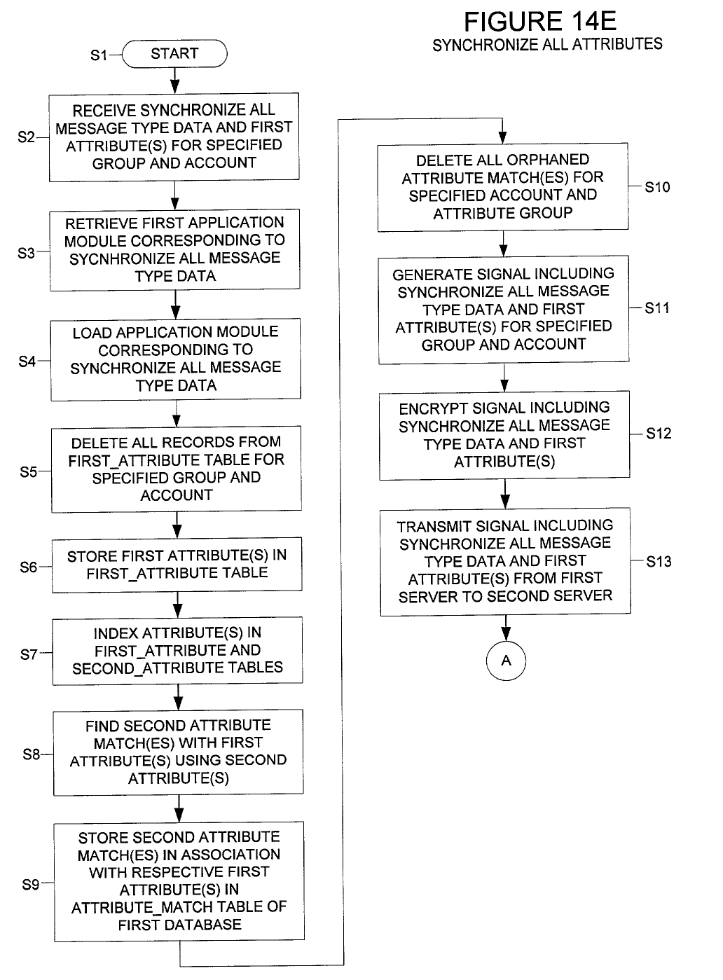

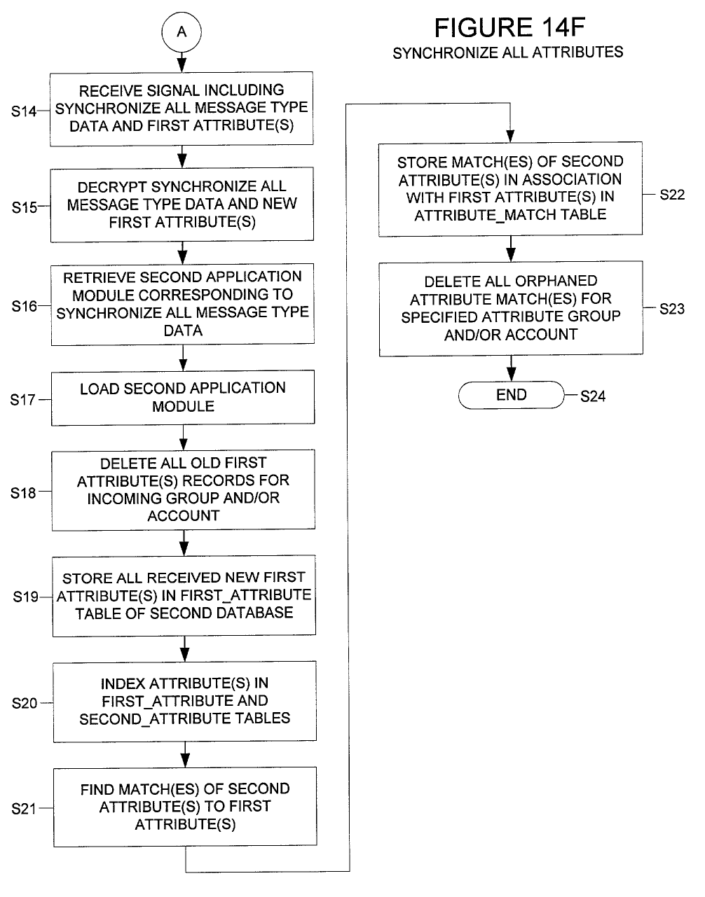

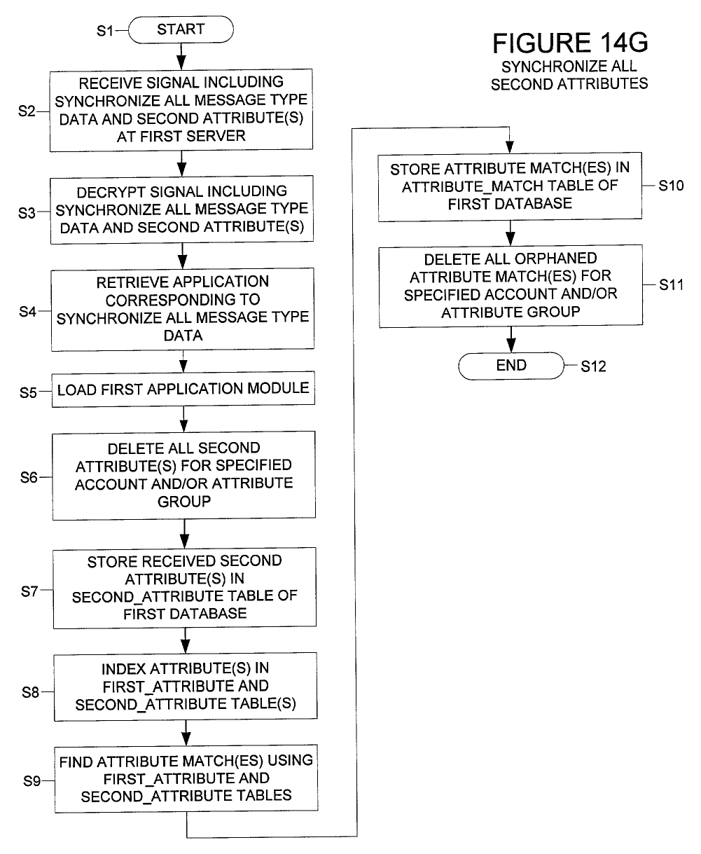

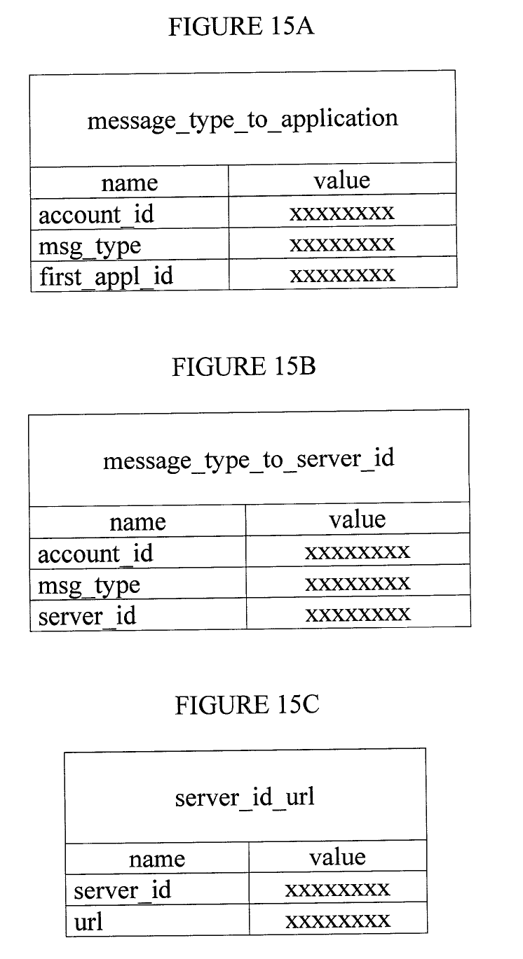

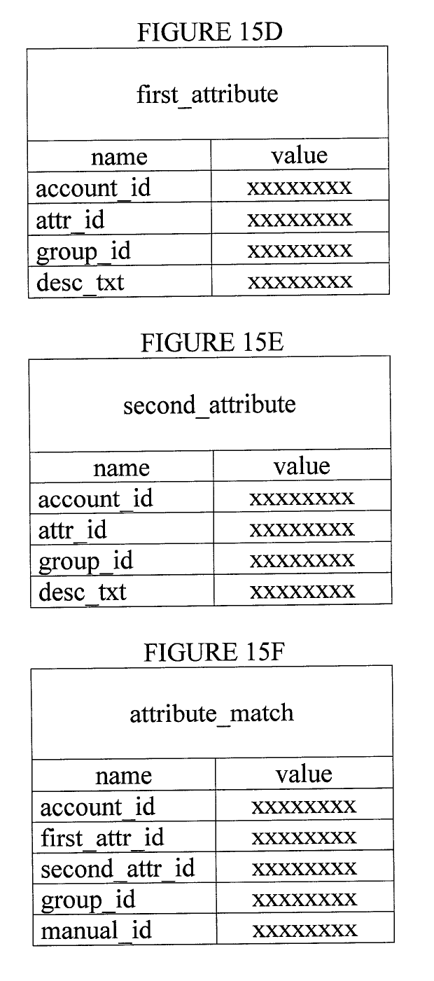

FIG. 14A is a method for creating a new first attribute record. in step S1 the method of FIGS. 14A and 14B begins. In step S2 the first server 10 and/or database server 121 receive insert message type and a new first attribute. The insert message type and new first attribute can be input by an operator or user of the first and/or second server(s). In step S3 the first server 10 retrieves a first application module corresponding to the insert message type data. In step S4 the first server 10 loads the first application module. Steps S5-S11 correspond to execution of the first application module. In step S5 the first and/or second server 10 and/or respective database server(s) store the new first attribute in the first_attribute table of the first database in the unit 12. In step S6 the first server 10 and/or first database server 121 index or normalize the new first attribute and second_attribute table. In step S7 the first server 10 and/or first database server 121 find match(es) in the second_attribute table for the new first attribute in the second_attribute table stored in the unit 12. In step S8 the first server and/or first database server stores the second attribute(s) in correspondence with the first attribute in the attribute_match table of the first database of the unit 12. In step S9 the first server 10 encrypts the insert message type and new first attribute. In step S10 the first server 10 generates a signal including the insert message type and new first attribute. In step S11 the first server 10 transmits the signal including the insert message type data and new first attribute to the second server(s) 20, 30. The first server 10 can transmit the signal to the second server(s) 20, 30 via the network 4. In step S12 the second server(s) 20, 30 receives the insert message type data and new first attribute from the first server 10. In step S13 the second server decrypts the insert message type data and new first attribute. In step S14 the second server(s) 20, 30 retrieves the second application module corresponding to the insert message type. In step S15 the second server(s) 20, 30 loads the second application module. Steps S16-S19 correspond to execution of the second application module. In step S16 the second server(s) 20, 30 stores the new first attribute in the first_attribute table. In step S17 the second server(s) 20, 30 and/or respective second database server(s) indexes the first_attribute and second_attribute tables. In step S18 the second server(s) 20, 30 and/or respective database server(s) finds match(es) of second attribute(s) from the second_attribute table to the new first attribute. In step S19 the second server(s) and/or second database server(s) store any second attribute(s) matching the new first attribute, in correspondence with such first attribute in the attribute_match table of the second database(s) stored in the unit(s) 22, 32. In step S20 the method of FIG. 14A ends.

With reference to FIGS. 14B and 14C a method of updating a first attribute is now described. In step S1 of FIG. 14B the method begins. In step S2 the first server 10 receives the first attribute from the first client device 11. In step S3 the first server 10 retrieves a first application module corresponding to the update message type. In step S4 the first server 10 loads the first application module. Steps S5-S17 are steps performed by the first server 10 in the execution of the first application module. In step S5 the first server 10 and/or first database server 121 checks the first_attribute table of the first database stored in unit 12 for the first attribute. In step S6 the first server 10 and/or first database server 121 determines whether the first attribute is present in the first_attribute table. If not, in step S7 the first server 10 and/or first database server 121 stores the new first attribute in the first_attribute table. In step S8 the first server 10 and/or first database 121 indexes the first_attribute and second_attribute tables. In step S9 the first server 10 and/or database server 121 find match(es) for the new first attribute from the second attribute(s) stored in the second_attribute table. In step S10 the first server 10 and/or database server 121 store the second attribute match(es) for the new first attribute in the database storage unit 12. On the other hand, if the determination in step S6 is affirmative, in step S11 the first server 10 and/or database server 121 determines whether the attribute or attribute group has changed in the new first attribute relative to the old first attribute. If the determination in step S11 is affirmative, in step S12 the first server 10 and/or database server 121 deletes the previous first attribute and all dependent matches. After performance of step S12 or if the determination in step S11 is negative, in step S13 the first server 10 and/or database server 121 determines whether the attribute description has changed. If so, in step S14 the first server 10 and/or database server 121 updates the description for the new first attribute. After performance of step S14 or if the determination in step S13 is negative, in step S15 the first server 10 encrypts the first attribute. In step S16 the first server 10 generates a signal including the encrypted first attribute. In step S17 the first server 10 transmits the signal including the first attribute to the second server(s) 20, 30. The first server 10 can transmit the signal including the first attribute from the first server to the second server via the network 4. In step S18 the second server(s) 20, 30 receives the signal including first-attribute-update message type and the first attribute data. In step S19 the second server(s) 20, 30 decrypts the message type and first attribute data. In step S20 the second server(s) 20, 30 retrieves the second application module corresponding to the update message type. In step S21 the second server(s) 20, 30 loads the second application module. Steps S22-S31 correspond to processing performed by the second server(s) 20, 30 in its execution of the second application module. In step S22 the second server(s) 20, 30 checks the first_attribute table stored in unit(s) 22, 32. In step S23 the second server(s) and/or second database server(s) determine whether the received first attribute is present in the second_attribute table stored in the second database(s) of the unit(s) 22, 32. If the determination in step S23 is negative, in step S24 the second server(s) 20, 30 and/or second database server(s) store the first attribute in the first attribute table of the second database(s) stored in unit(s) 22, 32. In step S25 the second server(s) and/or second database server(s) index the first_attribute and second_attribute tables. In step S26 the second server(s) and/or second database server(s) find match(es) for the first attribute from the second_attribute table stored in the unit(s) 22, 32. In step S27 the second server(s) 20, 30 and/or second database server(s) store the new first attribute in the attribute_match table of the unit(s) 22, 32, in correspondence with the matching second attribute(s). On the other hand, if the determination in step S23 is affirmative, in step S28 the second server(s) 20, 30 and/or second database server(s) determines whether the attribute or attribute group has changed. If so, in step S29 the second server(s) 20, 30 and/or second database server(s) delete the previous first attribute and all dependent second attribute matches. After performance of step S29 or if the determination in step S28 is negative, in step S30 the second server(s) 20, 30 and/or second database server(s) determine whether the first attribute description has changed. If so, in step S31 the second server(s) 20, 30 and/or second database server(s) update the first attribute description in the first_attribute table stored in the unit(s) 22, 32. After performance of steps S27, S31 or if the determination in step S30 is negative, the method of FIGS. 4B and 4C ends in step S32.

FIG. 14D is a flowchart of a method for deleting an attribute. The method begins in step S1 of FIG. 14D. In step S2 the first server 10 receives delete message type data and data identifying an attribute. In step S3 the first server 10 retrieves a first application module corresponding to the delete message type data. In step S4 the first server 10 loads the first application module on the first server 10. In step S5 the first server 10 and/or the database server 121 deletes the attribute record from appropriate table, either the first_attribute table or second_attribute table, in the first database. In step S6 the first server and/or database server 121 deletes the associated attribute match(es) from the attribute_match table of the first database. In step S7 the first server 10 encrypts the delete message type data and the attribute identification data. In step S8 the first server 10 generates a signal including the delete message type and attribute identification data. In step S9 the first server 10 transmits the signal including the delete message type and attribute identification data from the first server 10 to the second server(s) 20, 30. The first server 10 can transmit the signal to the second server(s) 20, 30 via the network 4. In step S10 the second server(s) 20, 30 receives the signal including the delete message type and the attribute identification data. In step S11 the second server(s) 20, 30 decrypts the delete message type and attribute identification data. In step S12 the second server(s) 20, 30 retrieve the second application module corresponding to the delete message type. In step S13 the second server(s) 20, 30 loads second application module. In step S14 the second server(s) and/or second database server(s) deletes the attribute record from the first_attribute or second_attribute table in the second database of the unit(s) 22, 32. In step S15 the second server(s) 20, 30 delete associated attribute match(es) from the attribute_match table of the second database(s) stored in the unit(s) 22, 32. In step S16 the method of FIG. 14D ends.

FIGS. 14E and 14F are flowcharts of a method for synchronizing the first and second sites to first attributes. In step S1 of FIG. 14E the method begins. In step S2 the first server 10 receives a synchronize-all message type and first attribute(s) for a specified attribute group and account. In step S3 the first server 10 retrieves the first application module corresponding to the synchronize-all message type data. In step S4 the first server 10 loads the application module corresponding to the synchronize-all message type data. Steps S5-S13 correspond to the execution of the first application module by the first server 10. In step S5 the first server 10 and/or database server 121 deletes all records from the first_attribute table. This can be done for the specified group and account. In step S6 the first server 10 and/or database server 121 stores the first attribute(s) in the first_attribute table. In step S7 the first server 10 and/or database server 121 indexes the first attribute(s) in the first_attribute table. In step S8 the first server 10 and/or database server 121 finds the second attribute match(es) for the new first attribute(s). In step S9 the first server 10 and/or database server 121 stores the second attribute match(es) in association with respective first attribute match(es) in the attribute_match table of the first database stored in the unit 12. In step S10 the first server 10 and/or database server 121 deletes all orphaned attribute match(es) for the specified attribute and/or account. In step S11 the first server 10 generates a signal including synchronize-all message type data and the first attribute(s). In step S12 the first server 10 encrypts the signal including the synchronize-all message type data and the first attribute(s). In step S13 the first server 10 transmits the signal including the synchronize-all message type data and the first attribute(s) from the first server 10 to the second server(s) 20, 30. The first server 10 can transmit this signal to the second server(s) 20, 30 via the network 4. In step S14 the second server(s) 20, 30 receives the signal requesting synchronization of all new first attribute(s) from the first server 10. In step S15 the second server(s) 20, 30 decrypts the new first attribute(s) received from the first server 10. In step S16 the second server(s) 20, 30 retrieve the second application module corresponding to the synchronize-all message type data. In step S17 the second server(s) 20, 30 load the second application module. In step S18 the second server(s) 20, 30 deletes all old first attribute(s) from the first_attribute table stored at the second server(s) 20, 30. In step S19 the second server(s) 20, 30 stores all received new first attribute(s) in the first_attribute table of the second database(s) store in unit(s) 20, 30. In step S20 the second server(s) 20, 30 indexes the attribute(s) in the first_attribute and second_attribute tables. In step S21 the second server(s) 20, 30 finds match(es) for second attributes to the new first attributes using the first_attribute and second_attribute tables. In step S22 the second server(s) 20, 30 and/or respective second database server(s) store any match(es) of second attribute(s) in association with first attribute(s) in the attribute_match table of the second database(s) stored in the unit(s) 22, 32. In step S23 the second server(s) deletes all orphaned attribute match(es) for the specified attribute group and/or account. In step S24 the method of FIGS. 14E and 14F ends.

The method of FIG. 14G relates to synchronization of all second attribute(s) received from the second server(s) 20, 30 to first attribute(s) stored at the first server 10. In step S1 the method of FIG. 14G begins. In step S2 the first server 10 receives the signal requesting synchronization of second attribute(s) to first attribute(s) at the first server 10. In step S3 the first server 10 decrypts the signal requesting synchronization of attribute(s). In step S4 the first server 10 retrieves the application corresponding to the synchronize-all message type data. In step S5 the first server 10 loads a first application module corresponding to the synchronize-all data message type. Steps S6-S11 correspond to the first server's execution of the first application module. In step S6 the first server 10 deletes all second attribute(s) for the account and/or attribute group indicated in the signal from the second server(s) 20, 30. In step S7 the first server stores the second attribute(s) in the second_attribute table of the first database. In step S8 the first server 10 indexes the attribute(s) in the first_attribute and second_attribute tables of the first database. In step S9 the first server 10 finds the attribute match(es) using the first_attribute and second_attribute tables. In step S10 the first server 10 stores the attribute match(es) in the attribute_match table of the first database. In step S11 the first server 10 deletes all orphaned attribute match(es) for the specified account and/or attribute group. In step S12 the method of FIG. 14G ends.

10. Database Record Formats

FIG. 15A is an exemplary record of the message_type_to_application table stored in the first database. The record includes fields account_id, msg_type, and first_appl_id having respective values. The value associated with the account_id field specifies account data associated with a particular user or organization having its own attribute(s) and application(s) pertinent to its operation. The value associated with the msg_type field identifies the type of message. The value of the first_appl_id field indicates the application associated with the message type and account data for the record.

FIG. 15B is an exemplary record of the message_type_to_server_id table stored in the first database. The record includes account data associated with the field name account_id, message type data associated with the field name msg_type, and server identification data associated with the field name server_id. The value associated with the account_id field has a value that identifies the account of the user(s) or organization(s) to which the attribute(s) and application(s) pertain. The msg_type field has a value that identifies the type of message listed in the record. The server_id field has a value that uniquely identifies a second server associated with the account_id and msg_type data.

FIG. 15C is an exemplary record of the server_id_URL table. This record lists the server identification data indicated by the value associated with the server_id field name, in correspondence with the universal resource locator (URL) of the listed server. The first and/or second server(s) can store such record in respective database(s) to determine the URL of any server by its identification data. Such server(s) can use the URLs to transmit data to another server(s) via the network 4.

FIG. 15D is an exemplary record of the first_attribute table stored in the first and second databases. The first_attribute table has field names account_id, attr_id, group_id, and desc_txt associated with respective values. The account_id field name identifies the associated user or organization account. The attr_id field name is associated with a value that uniquely identifies the attribute associated with such field name. The group_id field name is associated with a value that identifies the group to which an attribute(s) belong. The desc_txt field name is associated with a value that describes the corresponding attribute identified by value of the attr_id field name.

FIG. 15E is an exemplary record of the second_attribute table stored in the first and second servers. The second_attribute table has field names account_id, attr_id, group_id, and desc_txt associated with respective values. The account_d field name identifies the associated user or organization account. The attr_id field name is associated with a value that uniquely identifies the attribute associated with such field name. The group_id field name is associated with a value that identifies the group to which an attribute(s) belong. The desc_txt field name is associated with a value that describes the corresponding attribute identified by value of the attr_id field name.

FIG. 15F is an exemplary record of the attribute_match table stored in the first and second server(s). The record of the attribute_match table includes values associated with respective field names account_id, first_attr_id, second_attr_id, group_id, and manual_id. The account_id field name identifies the associated user or organization account. The attr_id field name is associated with a value that uniquely identifies the attribute associated with such field name. The first_attr_id field name is associated with a value identifying a first attribute. The second_attr_id is associated with a value that uniquely identifies a second attribute that is matched to the first attribute identified by its corresponding field name first_attr_id. The group_id field name is associated with a value that identifies the group to which an attribute(s) belong. The manual_id field name is associated with a value that indicates whether or not the mapping of the second attribute to the first attribute was made by a server executing the method of FIGS. 12A and 12B, for example, or was made by a user in accordance with the method of FIG. 13, for example.

11. Message Format and Attribute Data

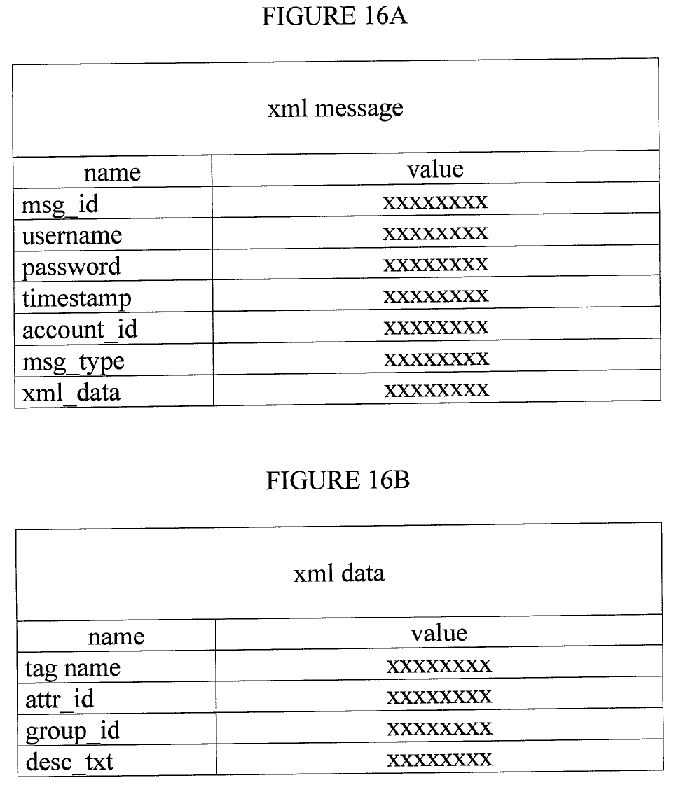

FIGS. 16A and 16B are exemplary views of message formats that can be used by the first and second servers to transmit messages and data to one another. The message can be in the form of an XML document, as shown in FIG. 16A. The message includes field names msg_id, username, password, timestamp, account_id, msg_type, and xml_data associated with respective values. The msg_id field is associated with a value that identifies the message and is a value that is automatically incremented by the first and second server(s) as they exchange messages. The message identification value is used in case of errors in transmission of messages, and is not relevant to this disclosure. The first_URL field is associated with a value that identifies the first URL of the server 10 that sent the message. The second_URL field is associated with a value that identifies the second server to which the message is to be sent. The second_URL value identifies the destination of the message and is a standard field associated with an XML message. The timestamp field name is associated with a value indicating the date and time at which the message was sent, which can be useful by the second and/or first servers to eliminate messages that are too aged to be of use. The account_id message has a value that identifies the user or organization account to which the message pertains. The msg_type field name has a value that indicates the type of message so that the second server can recognize how to handle the message. The xml_data field includes attribute data and/or result data. FIG. 16B indicates the xml_data included in the XML document.

12. XML Tags for Attribute Data

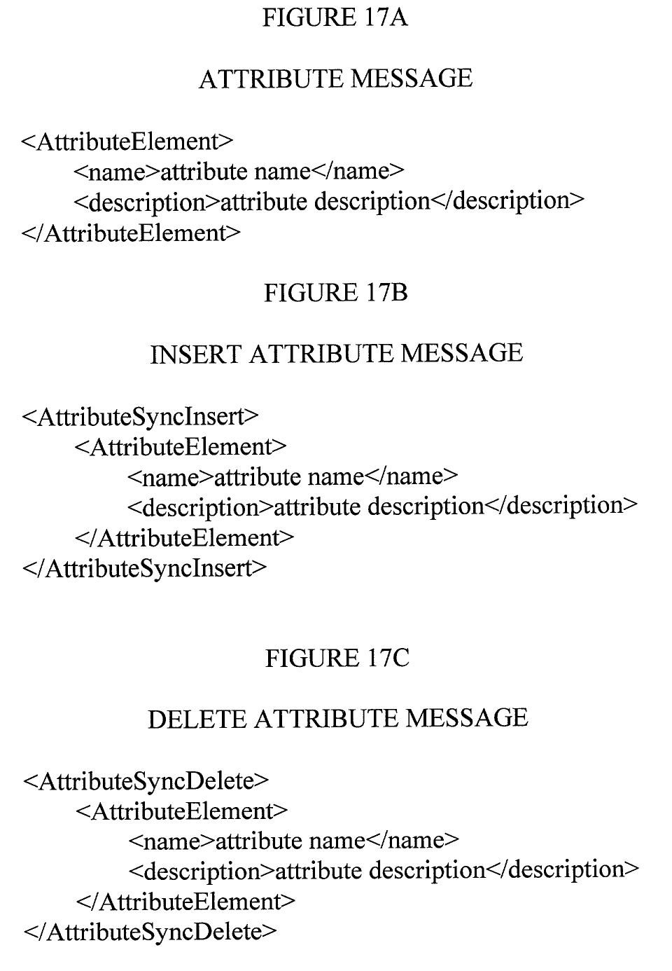

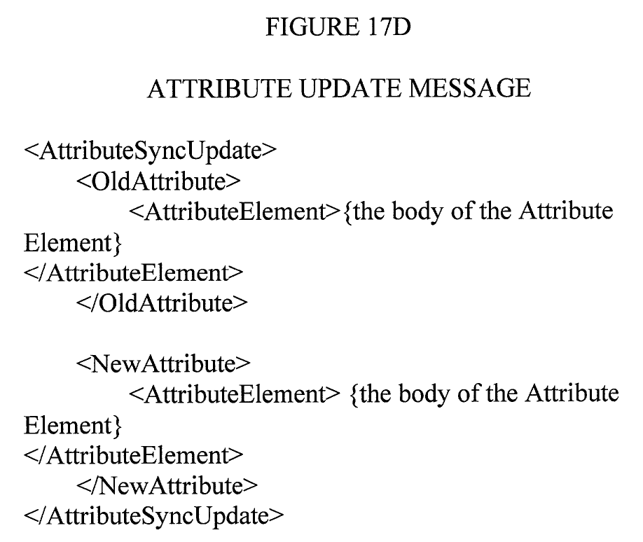

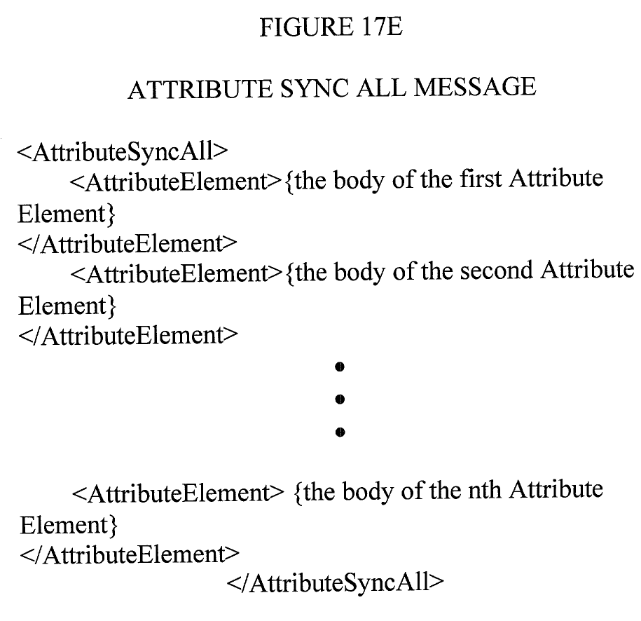

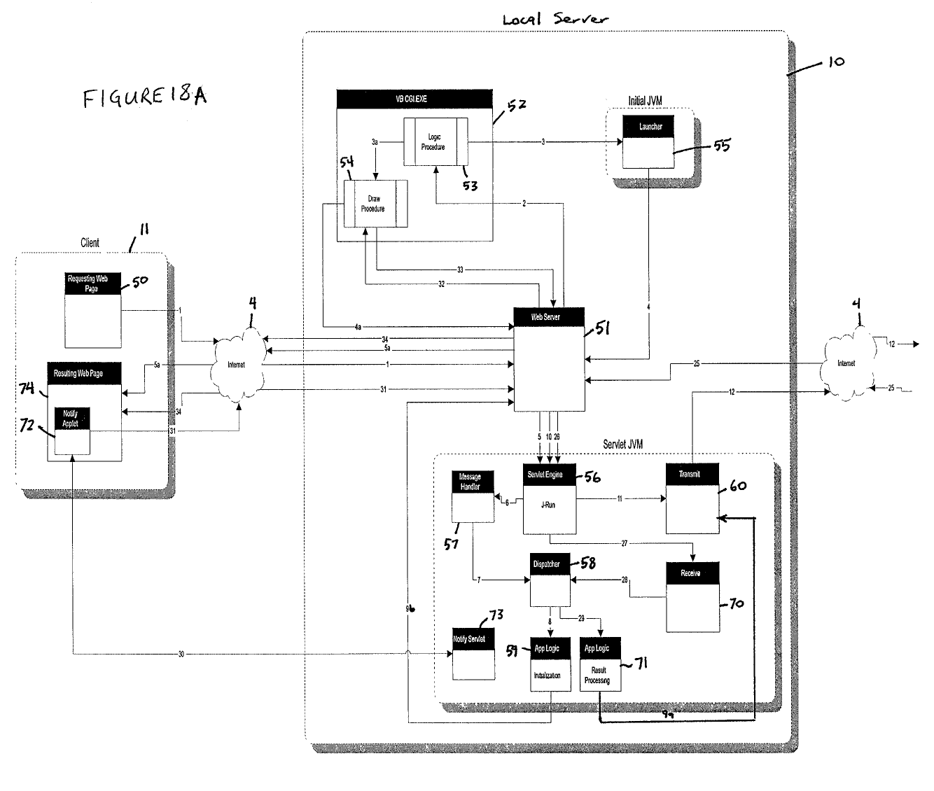

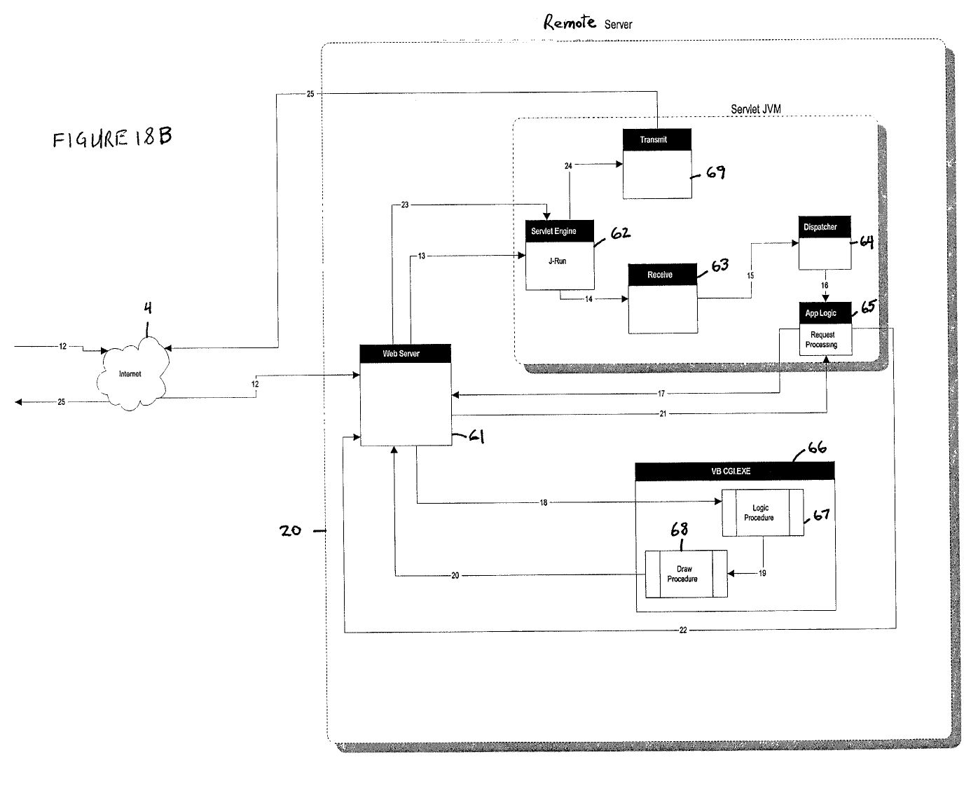

FIGS. 17A-17E are various XML tags for messages including different attributes that are transmitted between first and second server(s). The attribute message of FIG. 17A includes tags <AttributeElement> . . . </AttributeElement> to identify to the receiving server the start and end of the attribute. Inside of these tags is the <name> . . . </name> tags identify the attribute name. The <description> . . . </description> tags identify the attribute data that describes the attribute in terms of characters.

FIG. 17B is an insert attribute message that includes tags <AttributeSyncInsert> . . . </AttributeSyncInsert> to identify the start and end of the attribute, and alerts the receiving server of the message type “AttributeSyncInsert”. Inside of these message type tags is the <AttributeElement> . . . </AttributeElement> tags identify to delineate to the receiving server the attribute that is the subject of the attribute insert application associated with the AttributeSyncInsert message type that is to be executed by the receiving server. Inside of these message type tags, the <name> . . . </name> tags identify the start and end of an attribute name. Also inside of the attribute tags the <description> . . . </description> tags identify the attribute data that describes the attribute.

FIG. 17C is a delete attribute message that includes tags <AttributeSyncDelete> . . . </AttributeSyncDelete> to indicate to the receiving server the start and end of the message. The message type “AttributeSyncDelete” identifies to the receiving server that it is to execute the application for deleting an attribute. Inside of the tags <AttributeSyncDelete> . . . </AttributeSyncDelete> are the tags <AttributeElement> . . . </AttributeElement> that delineate the start and end of the attribute. The tags <name> . . . </name> delineate the start and end of the attribute name that defines the attribute in terms of the transmitting server's attribute convention. Also inside of the tags <AttributeSyncDelete> . . . </AttributeSyncDelete> are the tags <description> . . . </description> that describe the attribute in character words.

FIG. 17D is an attribute update message that includes tags <AttributeSyncDelete> . . . </AttributeSyncDelete> to delineate the update message. The <OldAttribute> . . . </OldAttribute> tags delineate the start and end of the old attribute. The <AttributeElement> . . . </AttributeElement> tags within the <OldAttribute> . . . </OldAttribute> tags indicate to the receiving server the old attribute that is to be replaced in its database with a new attribute. The <NewAttribute> . . . <NewAttribute> tags delineate the start and end of the new attribute. The <AttributeElement> . . . </AttributeElement> tags within the <NewAttribute> . . . </NewAttribute> tags delineate the new attribute to the receiving server, which the receiving server can store in its database to replace the old attribute. The new attribute can be described within the <AttributeElement> . . . </NewAttribute> tags in a similar manner as described with reference to FIG. 17A.

FIG. 17E is an attribute sync all message that includes tags <AttributeSyncAll> . . . </AttributeSyncAll> to identify the attributes accompanying the AttributeSyncAll message type. This message type identifies to the server receiving the message that such server is to execute the application associated with synchronizing all attributes of the receiving server with those included in the message. The <AttributeElement> . . . </AttributeElement> tags within the AttributeSyncAll message delineate the attributes 1-N included with the message. These attributes can be expressed in a format as described with respect to FIG. 17A.

13. Detailed Method

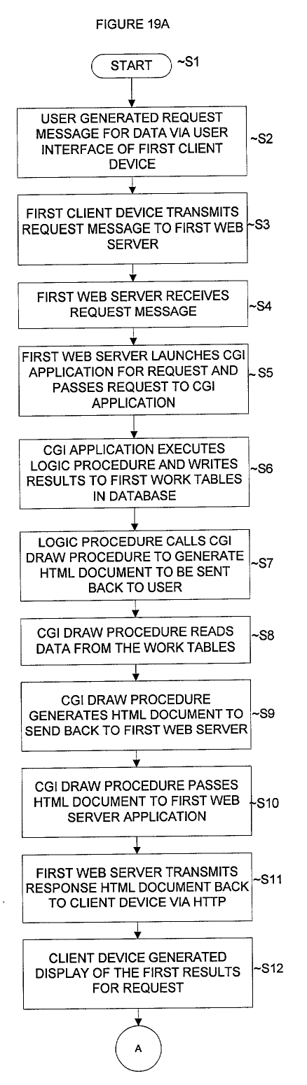

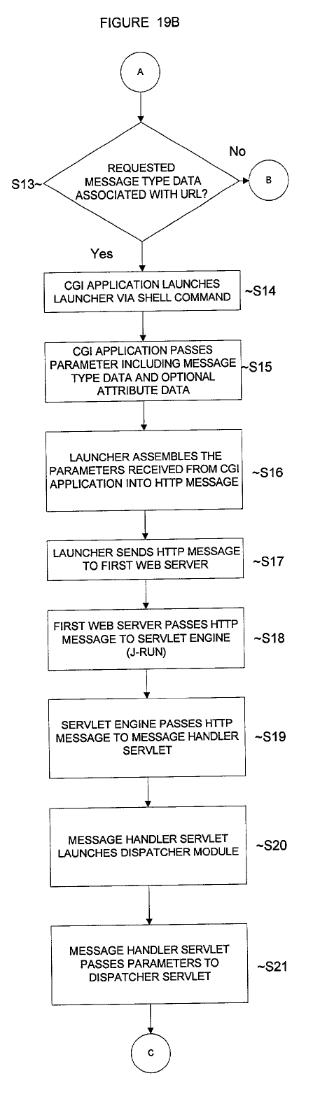

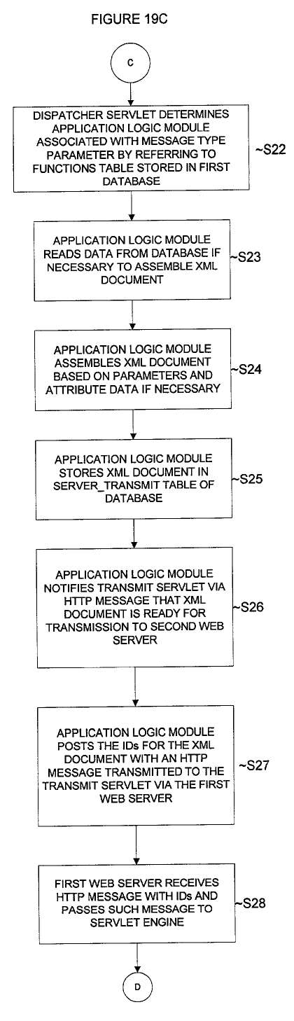

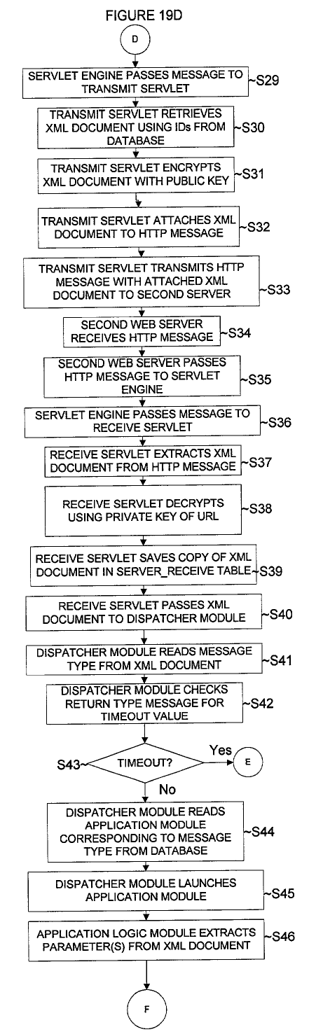

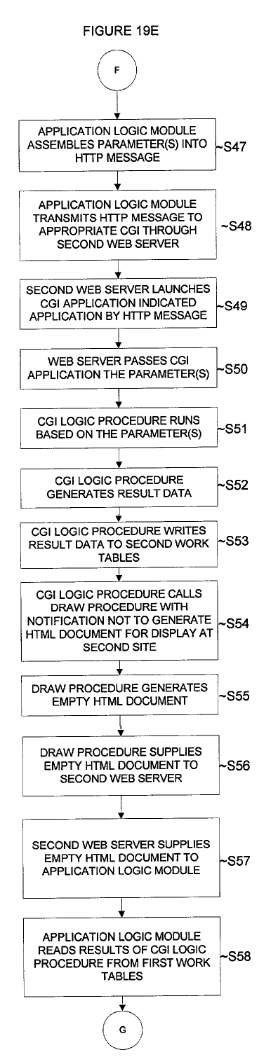

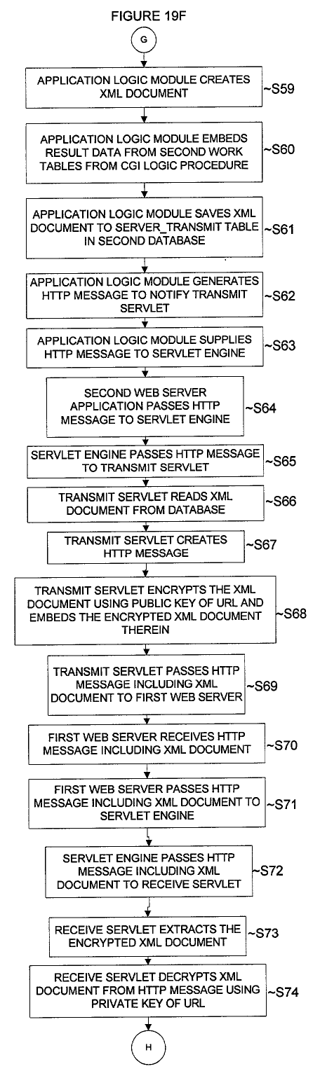

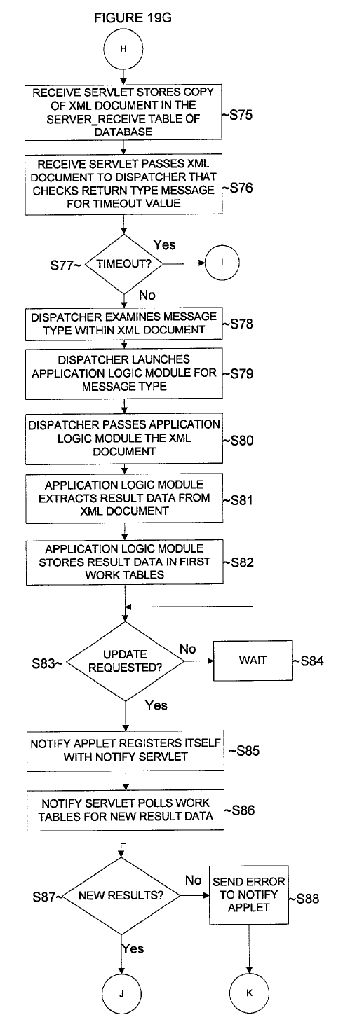

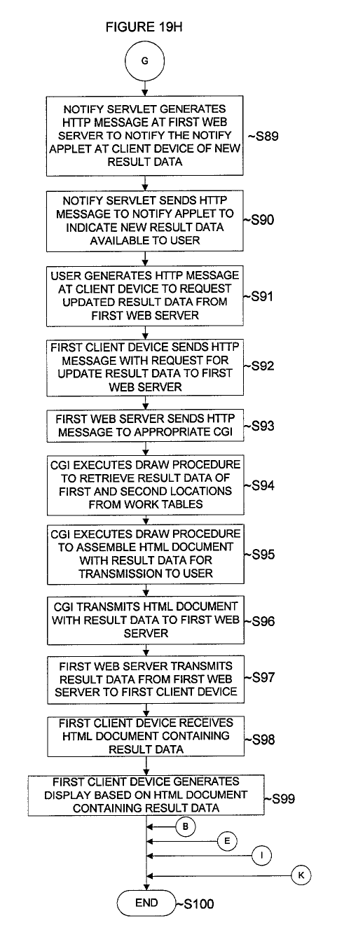

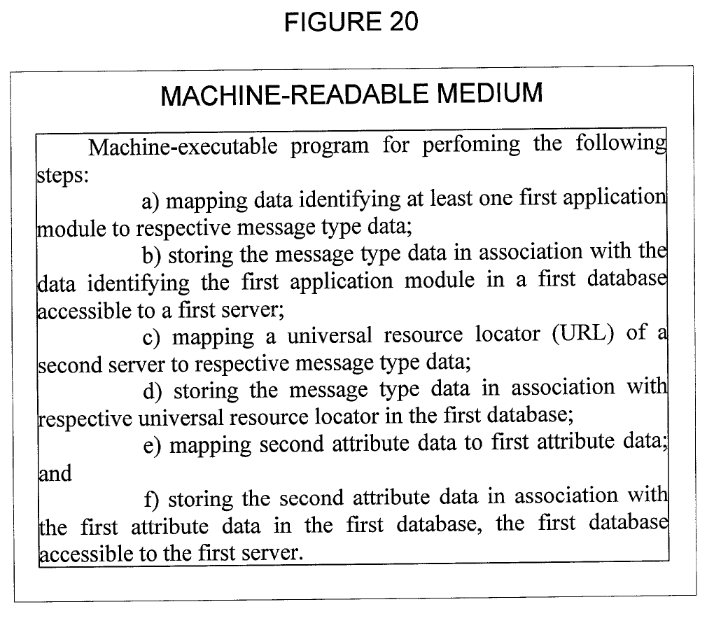

A relatively detailed method for using the mapping between the first and second application modules and the message type data, and the mappings between the first and second attribute data used in respective first modules, is now described with reference to FIGS. 18A and 18B and FIGS. 19A-19H. The action that is affected by the methods of FIGS. 18A and 18B and FIGS. 19A-19H is exemplary only and describes a particular situation in which the message type data is a request for data such as a data-send-all or data-match-send-all command because such command uses the fullest resources in terms of attributes and functions required to transmit and respond to such commands. However, other command forms such as data-insert, data-remove, and data-update will be readily understood from this description because their general action is similar to the first part of the method disclosed in FIGS. 18A and 18B and FIGS. 19A-19H although by their nature these commands terminate without the need to transmit a response. Hence such commands parallel the first part of the method disclosed in FIGS. 18A and 18B, and FIGS. 19A-19H. In FIGS. 18A and 18B the signals passed between the various elements are numbered so that the sequence of steps will be more readily understood.

In step S1 the method of FIG. 19A begins. In step S2 of FIG. 19A, the user generates a request message for data via the user interface provided by the first client device 11. The request includes as parameters message type data specifying a first and/or second application module to be launched based thereon. The request can also include as a parameter attribute data if appropriate to the first or second application specified by the second attribute data. The request message can be generated with a requesting web page 50. In step S3 the message type data and optional attribute data are transmitted in the request message from the first client device 11 to the first web server 10. The request message can be transmitted between the first client device 11 and the first web server 10 via the internetwork 4 or a first-area network (LAN) or other network link. In step S4, the message type data and optional attribute data included within the request message are received at the first web server 10, or more specifically, the first web server application module 51. In step S5, the first web server 10 refers to the first database (not shown in FIGS. 18A and 18B) and launches the common gateway interface (CGI) application 52 associated with the message type data included within the request generated at the client device 11 (as established by performance of steps S2 and S3 in FIG. 2A). In step S6 the first web server 10 executes the logic procedure 53 and writes the result data resulting therefrom to first work tables in the first database. In step S7, the logic procedure 53 calls draw procedure 54 to generate HTML document based on the result data, to be sent back to the first client device 11 for the user. In step S8 the CGI draw procedure reads data from the first work tables stored in the first database. In step S9 the CGI draw procedure generates the HTML document based on the result data from the first work tables. In step S10 the CGI draw procedure passes the HTML document to the application 51 of the first web server 10. In step S11 the first web server 10 passes the response HTML document back to the first client device 11 via HTTP. In step S12 the client device 11 generates a display of the first result data for the request supplied by the user. In step S13 of FIG. 4B, during execution of the CGI logic procedure 53, the CGI application 52 determines whether the message type data included within the request message from the first client device 11 is associated with URL data. If so, in step S14 the CGI application 51 launches launcher 55 via a shell command. In step S15 the CGI application 52 passes the launcher 55 parameters including the message type data and optionally also the attribute data if included therein. In step S16 the launcher 55 assembles the parameters receive from the CGI application into an HTTP message. In step S17 the launcher 55 sends an HTTP message to the first web server application 51 including the message type data and optional first attribute data as parameters. In step S18 the first web server application 51 passes the HTTP message to servlet engine 56 (“j-run”). In step S19 the servlet engine 56 passes HTTP message to message handler servlet 57. In step S20 the message handler servlet launches the dispatcher module 58. In step S21 the message handler servlet 57 passes parameters of message to dispatcher servlet 58. In step S22 the dispatcher servlet 58 determines second application logic module 59 associated with associated with message type parameter by referring to functions table stored in the first database. In step S23 the application logic module 59 reads data from the first database if needed to assemble XML document. In step S24 the application logic module 59 assembles the XML document based on parameters and attribute data if necessary. In step S25 the application logic module 59 stores the XML document in the server_transmit table in the first database. In step S26 the application logic module 59 notifies the transmit servlet 60 via HTTP message that the XML document is ready for transmission to second web server 20 (for simplicity the corresponding description of what transpires in the site 3 is not presented since it mirrors the steps in the site 2). In step S27 the application logic module 59 posts the IDs for the XML document with an HTTP message transmitted to the transmit servlet 60 via the first web server application 51. In step S28 the first web server application 51 receives the HTTP message with IDs and passes such message to the servlet engine 56. In step S29 of FIG. 4D the servlet engine 56 passes the HTTP message to the transmit servlet 60. In step S30 the transmit servlet 60 retrieves the XML document using IDs from the first database. In step S31 the transmit servlet 60 encrypts the XML document with a public key associated with the URL. In step S32 the transmit servlet 60 attaches the encrypted XML document to the HTTP message. In step S33 the transmit servlet 60 transmits the HTTP message including the encrypted XML document to the second web server 20. In step S34 the second server 20, or more specifically its application 61, receives the HTTP message with the encrypted XML document including the message type data and optional attribute data as parameters. In step S35 the second server application 61 passes the received HTTP message to the servlet engine 62. In step S36 the servlet engine 62 passes the HTTP message to the receive servlet 63. In step S37 the receive servlet 63 extracts the encrypted XML document from the HTTP message. In step S38 the receive servlet 63 decrypts the XML document using private key data corresponding to the URL. In step S39 the receive servlet 63 saves a copy of the XML document in a server_receive table stored in the second database in the unit 22. In step S40 the receive servlet 63 passes the XML document to dispatcher module 64. In step S41 the dispatcher module 64 reads message type data from the XML document. In step S42 the dispatcher module 64 checks return type message for the timeout value. In step S43 the dispatcher module 64 determines whether the message has timed out. If not, in step S44 the dispatcher module 64 reads the second application module for the message type data from the second database (such association is made in steps S8 and S9 of FIG. 2B). In step S45 the dispatcher module 64 launches the application module 65. In step S46 the application logic module 65 extracts parameter(s) including the message type data and optional attribute data from the XML document. In step S47 of FIG. 4E, the application logic module 65 assembles parameter(s) into an HTTP message. In step S48 the application logic module 65 transmits the HTTP message to the appropriate CGI application 66 indicated by message parameters. In step S49 the second web server application 61 launches the CGI application 66 indicated by the HTTP message. In step S50 the second web server 61 passes CGI application 66 the parameters contained in the message. In step S51 the CGI logic procedure 67 runs based on the parameters passed thereto. If necessary for the message type the CGI logic procedure 67 will translate the first attribute data into corresponding second attribute data (as established in steps S12 and S13 of FIG. 2B). In step S52 the CGI logic procedure generates result data. In step S53 the CGI logic procedure writes result data to second work tables in the second database. In step S54 the CGI logic procedure calls the draw procedure 68 with notification not to generate HTML document for display at the second site 2. In step S55 the draw procedure 68 generates an empty HTML document to second web server application 61. In step S56 the draw procedure 68 supplies the empty HTML document to the second web server application 61. In step S57 the second web server application 61 supplies the empty HTML document to the application logic module 65. In step S58 the application logic module 47 reads result data generated by the CGI logic procedure 67 from second work tables stored in second database in the unit 22. In step S59 of FIG. 4F the application logic module 65 creates an XML document. In step S60 the application logic module 65 embeds result data from first work tables stored in the second database in the unit 22. In step S61 the application logic module 65 saves the XML document to a server_transmit table in the second database. In step S62 the application logic module 65 generates an HTTP message to notify transmit servlet that a message is ready to be sent. In step S63 the application logic module 65 passes the HTTP message to the second web server application 61. In step S64 the second web server application 61 passes the HTTP message to the servlet engine (“j-run”) 62. In step S65 the servlet engine 62 passes HTTP message to transmit servlet 69. In step S66 the transmit servlet 69 reads the XML document from the second database stored in the unit 22. In step S67 the transmit servlet 69 creates an HTTP message. In step S68 the transmit servlet 69 encrypts the XML document using the public key data for the URL to be used to respond to request message from the first server 10, and the transmit servlet 69 embeds the encrypted XML document in the HTTP message. In step S69 the transmit servlet transmits the HTTP message including the encrypted XML document from the second server 20 over the internetwork 4 to the first web server 10. In step S70 the first web server 10, or more specifically the first web server application 51, receives the HTTP message including the encrypted XML document from the second server 20. In step S71 the first web server 10 passes the encrypted XML document to the servlet engine 56. In step S72 the servlet engine 56 passes the HTTP message including encrypted XML document to the receive servlet 70. In step S73 the receive servlet 70 extracts the encrypted XML document from the HTTP message. In step S74 the receive servlet 70 decrypts the XML document using the private key for the URL associated with the message type data. In step S75 of FIG. 4G the receive servlet 70 stores a copy of the decrypted document in the server_receive table of the first database in the unit 12. In step S76 the receive servlet 70 passes the XML document to the dispatcher 58. In step S77 the dispatcher 58 checks the message for timeout value. If no timeout has occurred, in step S78 the dispatcher 58 examines the message type data included within the XML document. In step S79 the dispatcher 58 launches the application logic module 71 based on the message type data. In step S80 the dispatcher 58 passes the application logic module 71 the decrypted XML document. In step S81 the application logic module 71 extracts the result data from the XML document. In step S82 the application logic module 71 stores the result data in first work tables of the first database in the unit 12. In step S83 the user determines whether update of the result data should be performed to include result data generated from the second server 20. In general, because the time to access the first database is less than the time required to access a second database, the user can be permitted to view first result data and request update with second result data upon availability thereof. If no update is requested, the application logic module waits in step S84 for a predetermined period of time such as a tenth of a second or less before checking for an update requests again in step S83. If the user requests an update with the second result data in step S83, in step S85, the notify applet 72 registers itself with the notify servlet 73. In step S86 the notify servlet polls the first work tables in the first database for new result data as it arrives from second server 20. In step S87 the notify servlet 73 determines whether new result data has arrived from the second server 20. If not, in step S88, the notify servlet 73 generates and transmits an error message to the notify applet 72 that in turn receives and generates an error message to the user via the user interface of the first client device 11. On the other hand, if the determination of step S87 establishes that new result data is available, in step S89 of FIG. 19H the notify servlet 73 generates an HTTP message at the first web server 10 to notify the notify applet 72 on the web page 74 at the first client device 11 of the new result data. In step S90 the notify servlet 73 sends the HTTP message to the notify applet 72 to indicate that new result data is available to the user. In step S91 the user generates an HTTP message at the first client device 11 to request updated result data from the first web server 10. In step S92 the first client device 11 sends an HTTP message with request for update with new result data to the first web server application 51. In step S93 the first web server application 51 sends the HTTP message to a corresponding CGI application 52. In step S94 the CGI application 52 executes a draw procedure to retrieve result data for first and second sites 1, 2 from the first work tables stored in the database. In step S95 the CGI application 52 executes the draw procedure to assemble the HTML document with new result data for transmission to user. In step S96 the CGI application transmits the HTML document with the result data to the first web server application 51. In step S97 the first web server application 51 transmits the HTML document including the new result data to the first client device 11. In step S98 the first client device 11 receives the HTML document including the result data. In step S99 the first client device 11 generates a display for the user via its user interface and the received HTML document including the result data. If the determination in step S13 is negative, the determinations in steps S43 or S77 are affirmative, or after performance of steps S88 or S99, the method FIGS. 19A-19H ends in step S100.

Although the method of FIGS. 19A-19H has been described with respect to a request message because it involves the full range of possibilities as to use of the message type data, attribute data, and result data, it should be appreciated that other message types can be used to generate other actions. For example, in addition to data request message types such as a data-send-all command to which the method of FIGS. 19A-19H is applicable, steps S1-S12 of such method can be applied to first data-insert or data-remove commands with the appropriate CGI application 52. In typical applications data-insert or data-remove commands would not be permitted by the operators of the second sites 1, 2 although there is no absolute prohibition that this be so. Steps S1-S51 of the method can be used to post an update in the first attributes to be included or removed in the first database and second database in the unit 22 can be “synced” with the first database. Steps S13-S51 or S3-S100 can be used to affect command actions that have no first action to be affected by a first application module, steps S13-S51 used for a non-response message type, and steps S13-S100 used for a response message type. Other message types and corresponding first and/or second application modules will readily occur to those skilled in this art. In addition, a second user can access the first site using message type data and optional second attribute data in a reciprocal manner to the methods described hereinabove with respect to the first user.

14. Examples

The disclosed system and methods can be used in numerous contexts. For example, the attributes can describe at one site a particular type of worker, such as “Visual Basic® programmer”, “Java® programmer”, “Java® DataBase Connectivity (JDBC) programmer”, “Open DataBase Connectivity (ODBC) programmer”, etc. Additional attribute(s) for such worker might include dates of availability to work, additional qualifications such as years of experience, and personal data such as social security number, salary requirements, and other information required for employment. These attributes can be mapped to attributes at a different site in the convention used by such site. For example, in the case of an attribute “Java programmer” at a first site such skill may map to “programmeur de Java” at a second site. In this case the difference in attribute occurs due to a difference in languages used at the two sites. In the context of a vehicle application of the system and methods, for example, an attribute “truck” in the convention of one site can map to the attribute “lorry” in the convention of another. The attribute “hood” in the convention of the first site can map to the attribute “bonnet” in the convention of the second site. The later two examples are cases in which the conventions of the two sites use different attributes to describe the same thing. An example of matching attributes that are relatively close in meaning but not identical, the attribute “peach” might map to “nectarine.” These attributes can fall under the attribute group “fruit” at each site, for example, in the taxonomy of this example. The attribute matching can thus be performed in a manner to map attributes in the conventions of different sites that are sufficiently close in meaning to one another to be considered matching even though not identical in meaning.

Apart from the applications used to insert, delete, update, and synchronize the attributes, the applications used by the user or organization account can be business- or organization-specific. For example, in the foregoing examples, that application can be such as to execute a contract to employ a worker for a specified date and time range described by the attributes, or to purchase a vehicle described by the attributes, or to send fruit of a kind described by the attribute to a designated person. These are of course but a small sampling of the possible applications of the disclosed system and method, and it should be appreciated that the disclosed system and methods are readily transferable to virtually any use in which different sites interact or share data but use different conventions to describe that data.

The many features and advantages of the present invention are apparent from the detailed specification and thus, it is intended by the appended claims to cover all such features and advantages of the described system, methods, which follow in the true spirit and scope of the invention. Further, since numerous modifications and changes will readily occur to those of ordinary skill in the art, it is not desired to limit the invention to the exact construction and operation illustrated and described. Accordingly, all suitable modifications and equivalents may be resorted to as falling within the spirit and scope of the invention.

1. A method comprising the steps of:
a) mapping data identifying at least one first application module to respective message type data;
b) storing the message type data in association with the data identifying the first application module in a first database accessible to a first server;
c) mapping a universal resource locator (URL) of a second server to respective message type data;
d) storing the message type data in association with respective universal resource locator in the first database;
e) mapping second attribute data to first attribute data; and
f) storing the second attribute data in association with the first attribute data in the first database, the first database accessible to the first server.

2. A method as claimed in claim 1 further comprising the steps of:
g) mapping the data identifying at least one second application module to respective message type data;
h) storing the message type data in association with the data identifying the second application module in the second database;
i) mapping a universal resource locator for the first server in association with respective message type data;
j) storing the message type data in association with respective universal resource locator in the second database;
k) mapping first attribute data to second attribute data; and
l) storing the first attribute data in association with the second attribute data in the second database.

3. A method as claimed in claim 2, further comprising the step of:
m) generating message type data at a first client device;
n) transmitting the message type data from the first client device to the first server;
o) receiving the message type data transmitted in the step (n) at the first server;
p) determining whether the message type data received in the step (o) is associated with a first application module;
q) running the first application module if the step (p) determines that the message type data is associated with the first application module;
r) determining whether the message type data received in the step (o) is associated with a universal resource locator;
s) transmitting over an internetwork the message type data from the first server to the second server using the universal resource locator, if the step (r) determines that the message type data is associated with the universal resource locator;
t) receiving the message type data at the second server;
u) determining whether the message type data is mapped to a second application module in the second database;
v) reading the second application module from the second database if the step (u) determines that the message type data is mapped to the second application module; and
w) running the second application module on the second server.

4. A method as claimed in claim 3, wherein attribute data is generated at the client device in the step (m) in association with the message type data, the attribute data is transmitted from the client device to the first server in the step (n), the attribute data is received at the first server in the step (o), and is transmitted from the first server to the second server in the step (s), the method further comprising the steps of:
x) reading second attribute data mapped to the first attribute data received in the step (s) from the second database for use by the second application module running in the step (w).

5. A method as claimed in claim 4, wherein the running of the second application module in the step (w) generates result data, further comprising the step of:
y) transmitting the result data from the second server to the first server over the internetwork;
z) receiving the result data at the first server;
aa) transmitting the result data from the first server to the first client device;
ab) receiving the result data at the first client device; and
ac) generating a display on the first client device, based on the result data received in the step (ab).

6. A method as claimed in claim 4, wherein the second application module performs a search of the second database for worker data type designated by the attribute data.

7. A method as claimed in claim 3, wherein the first application module performs a search of the first database for worker data type designated by the attribute data.

8. A method comprising the steps of:
a) mapping data identifying at least one first application module to respective message type data;
b) mapping the data identifying at least one second application module to respective message type data;
c) generating message type data at a client device;
d) transmitting at least message type data from the client device to a first server;
e) receiving the message type data transmitted in the step (d) at the first server;
f) determining at the first server the application program module designated to be run, based on the message type data received in said step (e);
if the message type data is determined in said step (f) to be associated with a first application program module,
g) running the first application program module on the first server; and
h) determining whether the message type data is associated with a universal resource locator (URL);
if the message type data is determined in said step (h) to be associated with the URL,
i) transmitting at least the message type data from the first server to the second server over an internetwork;
j) receiving the message type data at the second server; and
k) running the second application program module on the second server, based on the message type data received in said step (0).

9. A method as claimed in claim 8, further comprising the steps of:
l) mapping the second attribute data to the first attribute data;
m) storing the second attribute data in association with the first attribute data in the first database;
n) mapping the first attribute data to the second attribute data; and
o) storing the first attribute data in association with the second attribute data in the second server.

10. A method as claimed in claim 9, wherein said step (c) includes generating predetermined user-specified first attribute data from the client device to the first server, the first server using the first attribute data in the first application program module in the performance of said step (g).

11. A method as claimed in claim 10, wherein the second attribute data and first attribute data are mapped in at least one of said steps (l) and (n) through string matching.

12. A method as claimed in claim 11, wherein the second attribute data and the first attribute data are assigned numeric values as to relative similarity based on execution of a search engine and string matching that compares the character word values to determine first attribute data within a predetermined value from the second attribute data.

13. A method as claimed in claim 8, wherein the message type data is transmitted said steps (d) and (i) as an eXtensible Markup Language (XML) document.

14. A method as claimed in claim 8, further comprising the step of:
l) generating a message including the message type data generated in said step (c), for transmission in said step (d), the message generated to include header and data sections, the header section including the destination data designating a predetermined network address of the second server, message type data, first user data, and return trip data, the data section content based on the message type data.

15. A method as claimed in claim 14, wherein the user generates attribute data in addition to the message type data in the step (c), the message type data in the step (c) designating a search request, and the data section of the message includes attribute data for performance of the search request.

16. A method as claimed in claim 15, wherein the attribute data indicates at least one of worker data identification data and worker availability data, and the result data indicates corresponding worker data identification data and worker availability data resulting from searching a first database with the first server based on the search parameter data.

17. A method as claimed in claim 14, wherein the attribute data includes predetermined user-specified attribute data, and wherein the running of the application program module in said step (g) generates result data based on the user-specified attribute data, the method further comprising the step of:
m) transmitting the result data from the first server to the client device; and
n) generating a display on the client device, based on the result data.

18. A method as claimed in claim 14, wherein the message type data transmitted in said step (g) designates a search, and the performance of said step (g) generates result data, the method further comprising the step of:
m) generating a response message having header and data sections, the header section including network address data designating the first server, message type data, first user data, and return trip data, the data section including the result data; and
n) transmitting the response message from the second server to the first server.

19. A method as claimed in claim 18, further comprising the step of:
o) logging the message received at the second server in the step (i) with time stamp data;
p) receiving the result data transmitted from the second server in the step (m) at the first server;
q) logging the result data received in the step (o) with return time data;
r) comparing the time stamp data with the return time data; and
s) determining at the first server whether the result data is valid, based on the comparison of the step (q).

20. A method as claimed in claim in claim 17, wherein the response message is generated in said step (m) to be encrypted based on a public key for the first server stored in association with the network address of the first server in the second database, and wherein the encrypted response message is transmitted in the step (n), the method further comprising the step of:
o) decrypting the response message at the first server based on predetermined private key data prestored in association with the public key data.

21. A method as claimed in claim 14, wherein the generating is performed in said step (k) to encrypt the message using a public key prestored in the first database in association with the destination address of the second server, and wherein the message is received in the step (i), the method further comprising the step of:
m) reading from the second database private key data prestored in association with the network address data for the first server; and
n) decrypting the message from the first server at the second server, based on the private key data.

22. A method as claimed in claim 8, wherein the attribute data includes predetermined user-specified attribute data, and wherein the running of the application program module in said step (k) generates result data based on the user-specified attribute data, the method further comprising the step of:
l) transmitting the result data from the second server to the first server;
m) transmitting the result data from the first server to the client device; and
n) generating a display on the client device based on the result data.

23. A method as claimed in claim 22, wherein the attribute data includes at least one of worker data identification data and worker availability data, and the result data indicates corresponding worker data identification data and worker availability data resulting from searching the second database with the second server based on the attribute data.

24. A method as claimed in claim 8, wherein the attribute data includes predetermined user-specified search parameter data, and wherein the running of the application program module in said step (k) generates result data based on the user-specified attribute data, the method further comprising the step of:
l) transmitting the result data from the second server to the first server;
m) transmitting the result data from the first server to the client device; and
n) generating a display on the client device based on the result data.

25. A method as claimed in claim 8, wherein the attribute data includes at least one of worker data identification data and worker availability data, and the result data indicates corresponding worker data identification data and worker availability data resulting from searching the second database with the second server based on the attribute data.

26. A method as claimed in claim 8, wherein the universal resource locator is transmitted to the second server via the first server, and wherein the second server generates result data based on the performance of said step (k), the method further comprising the steps of:
l) transmitting the result data from the second server to the first server using the universal resource locator; and
m) transmitting the result data from the first server to the client device using the universal resource locator.

27. A method as claimed in claim 8, wherein said step (c) is performed using a hypertext transfer protocol (HTTP) POST request.

28. A method as claimed in claim 8, wherein the first application module is a servlet application program module.

29. A method as claimed in claim 1 wherein the step (e) is performed with first and second attribute(s) are different character words that identify the same thing.

30. A method as claimed in claim 1 wherein the step (e) is performed with first and second attribute(s) that are different character words that define the same thing in different languages between the site of the client device and first server, and the site of the second server.

31. A method as claimed in claim 1 wherein the step (e) is performed with first and second attribute(s) that are different character words that define the same thing due to different word usage conventions in the same language of a site of the client device and first server, as compared to a site of the second server.

32. A method as claimed in claim 1 wherein the step (e) is performed with first and second attribute(s) that mean different things but are sufficiently similar to be deemed matching.

33. A method comprising the step of:
a) inputting a command indicating a message type and first attribute(s) at a client device;
b) generating a signal indicating message type and first attribute(s) at a client device;
c) transmitting the signal indicating the message type and first attribute(s) from the client device to a first server;
d) receiving the signal indicating the message type and first attribute(s) at the first server;
e) executing a first application corresponding to the message type at the first server using the first attribute(s);
f) generating a signal including the message type and first attributes at the first server;
g) transmitting the signal including the message type and first attribute(s) from the first server to a second server;
h) receiving the signal including the message type and first attributes at the second server;
i) determining a second application corresponding to the message type;
j) determining second attribute(s) mapped to the first attribute(s); and
k) executing the second application with the second attribute(s).

34. A method as claimed in claim 33, wherein the execution of the step (d) results in generation of result data, further comprising the step of:
l) generating a signal including the result data at the first server;
m) transmitting the result data from the first server to the client device;
n) receiving the result data at the client device; and
o) generating a display based on the result data.

35. A method as claimed in claim 33, further comprising the steps of:
p) encrypting the result data at the first server before performing step (1); and
q) decrypting the result data at the client device before performing the step (o).

36. A method as claimed in claim 33, wherein the execution of the step (e) results in generation of result data, further comprising the step of:
l) generating a signal including the result data at the second server;
m) transmitting the result data from the second server to the first server;
n) receiving the result data at the first server;
o) transmitting the result data from the first server to the client device;
p) receiving the result data at the client device;
q) generating a display based on the result data.

37. A method as claimed in claim 36, further comprising the steps of:
r) encrypting the result data at the second server before performing step (1); and
s) decrypting the result data at the client device before performing the step (q).

38. A method as claimed in claim 33, further comprising the steps of:
r) encrypting the message type and first attribute(s) at the client device before performing step (c); and
s) decrypting the message type and first attribute(s) at the first server before performing step (e).

39. A method comprising the steps of:
a) receiving message type and first attribute data;
b) determining second attribute data based on the first attribute data;
c) determining an application based on the based on the message type data; and
d) executing the application based on the second attribute data.

40. A method as claimed in claim 39 wherein steps (a)-(d) are performed for an account.

41. A method comprising the steps of:
a) indexing a fromlist and tolist of attribute(s);
b) selecting an attribute(s) from the tolist;
c) searching the fromlist of attribute(s) with the selected attribute from the tolist;
d) determining whether an exact match of the selected attribute from the tolist is present in the fromlist of attributes;
if the determination in step (d) establishes that the selected attribute from the tolist is present in the fromlist of attributes,
e) storing the attribute from the tolist in association with the attribute from the fromlist;
if the determination in step (d) establishes that the selected attribute from the tolist is not present in the fromlist,
f) truncating the character string of the attribute from the tolist;
g) searching the fromlist of attributes with the truncated tolist attribute string;
h) determining whether a partial match of the selected attribute from the tolist matches an attribute from the fromlist;
if the determination in step (h) establishes the partial match of the selected attribute from the tolist partially matches an attribute from the fromlist,
i) storing the attribute from the tolist in association with the attribute from the fromlist;
if the determination in step (h) establishes the partial match of the selected attribute from the tolist does not partially match an attribute from the fromlist,
j) determining whether greater than a predetermined number of character words remain in the string of the attribute from the tolist, and
if the determination in step (j) determines that greater than the predetermined number of character words remain in the string of the attribute from the fromlist,
k) repeating step (f) and subsequent steps.

42. A method as claimed in claim 41 the method further comprising:
if the determination in step (j) determines that greater than the predetermined number of character words do not remain in the string of the attribute from the fromlist,
k) searching the fromlist of attribute(s) with the selected attribute from the to list for common character words;
l) determining whether a minimum number of words of an attribute from the fromlist match the attribute from the tolist;
if the determining in step (1) establishes that the minimum number of words of the attribute from the from list match the attribute form the tolist,
m) storing the attribute form the tolist in association with the attribute from the fromlist.

43. A method as claimed in claim 41 the method further comprising:
if the determination in step (j) determines that greater than the predetermined number of character words do not remain in the string of the attribute from the fromlist,
k) searching the fromlist of attribute(s) with the selected attribute from the to list for common character words;
l) determining whether a minimum proportion of words of an attribute from the fromlist match the attribute from the tolist;
if the determining in step (l) establishes that the minimum proportion of words of the attribute from the from list match the attribute form the tolist,
m) storing the attribute form the tolist in association with the attribute from the fromlist.

44. A method as claimed in claim 41 wherein an expert is used in the method, the method further comprising the step of:
l) reviewing matches of attributes from the fromlist and tolist by the expert;
m) determining whether the attributes form the fromlist and tolist match; and
if step (m) determines that the attributes from the fromlist and tolist do not match,
n) determining whether the fromlist has any attribute(s) corresponding to the attribute from the tolist;
if the determination in step (n) establishes that an attribute(s) in the fromlist matches the attribute from the tolist,
o) storing the attribute from the tolist in association with the attribute(s) from the fromlist.

45. A method comprising the steps of:
a) receiving a first attribute;
b) storing the first attribute;
c) indexing the first attribute and a second attribute(s);
d) finding match(es) if any between the first and second attributes;
e) storing match(es) between the first and second attributes.

46. A method as claimed in claim 45 wherein the steps (a)-(e) are performed at a first site, the method further comprising the steps of:
f) transmitting the first attribute from the first site to a second site; at the second site,
g) storing the first attribute;
h) indexing the first attribute and a second attribute(s);
i) finding match(es) if any between the first and second attribute(s); and
j) storing the second attribute(s) in corresponding with the first attribute.

47. A method comprising the steps of:
a) receiving a first attribute;
b) checking a first database for a first attribute;
c) determining whether the first attribute is present in the first database; if the first attribute is not present in the first database,
d) storing the first attribute;
e) indexing the first attribute and second attribute(s) stored in the first database;
f) finding match(es) if any between the first and second attributes;
g) storing any match(es) of the first and second attributes if found in step (f).

48. A method as claimed in claim 47, further comprising the steps of: if the first attribute is present in the first database,
h) determining whether the first attribute or attribute group has changed;
if the determination in step (h) indicates that the first attribute or attribute group has changed,
i) deleting the previous first attribute and all dependent match(es) with the second attribute(s) from the first database.

49. A method as claimed in claim 47, further comprising the steps of:
j) determining whether the attribute description has changed; and
if the determination in step (j) indicates that the attribute description has changed,
k) updating description of the first attribute.

50. A method as claimed in claim 47 wherein steps (a)-(g) are performed at a first site, the method further comprising the steps of:
h) transmitting the first attribute to a second site;
at the second site,
i) receiving the first attribute;
j) checking a second database for the first attribute;
k) determining whether the first attribute is present in the second database;
if the first attribute is not present in the second database,
l) storing the first attribute;
m) indexing the first attribute and second attribute(s) stored in the second database;
n) finding match(es) if any between the first and second attributes;
o) storing any match(es) of the first and second attributes if found in step (n) in the second database.

51. A method as claimed in claim 47, further comprising the steps of:
if the first attribute is present in the second database,
p) determining whether the first attribute or attribute group has changed;
if the determination in step (p) indicates that the first attribute or attribute group has changed,
q) deleting the previous first attribute and all dependent match(es) with the second attribute(s) from the second database.

52. A method as claimed in claim 47, further comprising the steps of:
j) determining whether the attribute description has changed; and
if the determination in step (j) indicates that the attribute description has changed,
k) updating description of the first attribute in the second database.

53. A method as claimed in claim 47 wherein the first and second attribute(s) pertain to an attribute group.

54. A method as claimed in claim 47 wherein the first and second attribute(s) pertain to an account.

55. A method comprising the steps of:
at a first site,
a) deleting an attribute record from a first database;
b) deleting associated attribute match(es) from the first database;
c) generating a request to delete the attribute record;
d) transmitting the request to delete the attribute record from the first site to a second site;
at the second site,
e) receiving the request to delete the attribute record;
f) deleting the attribute record from a second database;
g) deleting associated match(es) with the attribute record from the second database.

56. A method as claimed in claim 55 wherein the attribute record pertains to an attribute group.

57. A method as claimed in claim 55 wherein the attribute record pertains to an account.

58. A method comprising the steps of:
a) synchronizing first and second attributes at a first site;
b) transmitting a request to synchronize attributes from the first site to a second site;
c) synchronizing first and second attributes at a second site.

59. A method as claimed in claim 58 wherein step (a) includes substeps of:
a1) receiving first attribute(s);
a2) deleting previous first attribute(s);
a3) deleting all match(es) of second attributes from the first attribute(s);
a4) indexing the received first attribute(s) and second attribute(s) stored in a first database;
a5) finding match(es) of the first attribute(s) to the second attribute(s); and
a6) storing the match(es) of the first and second attribute(s) in the first database.

60. A method as claimed in claim 59, wherein the first attribute(s) are transmitted from the first site to the second site in step (b), the step (c) comprising the substeps of:
c1) receiving first attribute(s);
c2) deleting previous first attribute(s) from a second database;
c3) deleting dependent match(es) of the first and second attribute(s) from a second database;
c3) indexing the received first attribute(s) and second attribute(s) stored in the second database;
c4) finding match(es) of the first attribute(s) to the second attribute(s); and
c5) storing the match(es) of the first and second attribute(s) in the second database.

61. A method as claimed in claim 58 wherein steps (a)-(c) are performed for an attribute group.

62. A method as claimed in claim 58 wherein step (a)-(c) are performed for an account.

63. A machine-readable medium having a program for performing the following steps:
a) mapping data identifying at least one first application module to respective message type data;
b) storing the message type data in association with the data identifying the first application module in a first database accessible to a first server;
c) mapping a universal resource locator (URL) of a second server to respective message type data;
d) storing the message type data in association with respective universal resource locator in the first database;
e) mapping second attribute data to first attribute data; and
f) storing the second attribute data in association with the first attribute data in the first database, the first database accessible to the first server.

64. A signal comprising first tags indicating a message type, and second tags within the first tags indicating attribute(s).

65. A signal as claimed in claim 64 wherein the first tags are <AttributeElement> and </AttributeElement> tags to delineate the attribute(s).

66. A signal as claimed in claim 64 wherein the signal includes third tags within the second tags indicating the name of the attribute, and fourth tags indicating the description of the attribute(s).

67. A signal as claimed in claim 66 wherein the third tags are <name> and </name> tags that delineate the name of the attribute(s).

68. A signal as claimed in claim 66 wherein the fourth tags are <description> and </description> tags.

69. A signal as claimed in claim 64 wherein the first tags are <AttributeSyncInsert> and </AttributeSyncInsert> tags indicating an attribute insert application to be executed by a server receiving the signal.

69. A signal as claimed in claim 64 wherein the first tags are <AttributeSyncDelete> and </AttributeSyncDelete> tags indicating an attribute delete application to be executed by a server receiving the signal.

69. A signal as claimed in claim 64 wherein the first tags are <AttributeSyncUpdate> and </AttributeSyncUpdate> tags indicating an attribute update application to be executed by a server receiving the signal.

69. A signal as claimed in claim 64 wherein the first tags are <AttributeSyncAll> and </AttributeSyncAll> tags indicating a synchronize-all-attributes application to be executed by a server receiving the signal.

70. A system coupled via a network and operable by a first user, the system comprising:
a first site having at least one first client device, a first server, and a first database storage unit, the first client device operable by a first user to input a message type and first attribute(s), the first server coupled to receive the message type and first attribute(s) from the first client device, the first server executing a first application using the first attribute(s) based on the message type, the first server determining whether a request to execute a second application is to be generated based on the message type, the first server transmitting the message type and first attribute(s) to the second server via the network if the first server determines that the message type indicates the second application should be executed; and
a second site having a second server and a second database storage unit, the second server coupled to receive the message type from the first server, the second server determining second attribute(s) corresponding to the first attribute(s), the second server executing a second application based on the message type and second attributes.

71. A system as claimed in claim 70 wherein the second site includes a second client device operable by a second user, the second user inputting a message type and second attribute(s), the second client device transmitting the message type and second attribute(s) to the second server, the second server executing the second application based on the message type using the second attribute(s).

72. A system as claimed in claim 70 wherein the second server determines whether the first application should be executed based on the message type, the second server transmitting the message type and second attribute(s) to the first server if the second server determines that the message type indicates that the first application is to be executed, the first server receiving the message type and second attribute(s) if transmitted by the second server, the first server determining first attribute(s) corresponding to the second attribute(s), the first server executing the first application based on the determined first attribute(s).
